(19) United States
(12) Patent Application Publication
(10) Pub. No.: US 2024/0326062 A1
(43) Pub. Date: Oct. 3, 2024

(54) PLANETARY BALL MILL

(71) Applicant: FRITSCH GMBH, Idar-Oberstein (DE)

(72) Inventor: Wolfgang MUTTER, Bruchmühlbach-Miesau (DE)

(21) Appl. No.: 18/293,856

(22) PCT Filed: Jul. 29, 2022
(86) PCT No.: PCT/EP22/71365

§ 371 Date: Jan. 31, 2024

(30) Foreign Application Priority Data
Aug. 3, 2021 (DE) 10 2021 120 138.1

(51) Int. Cl. B02C 17/24; B02C 17/08

(52) U.S. Cl. CPC B02C 17/24; B02C 17/08

(57) ABSTRACT

A planetary mill for comminuting material to be ground includes a carrier device rotatable about a sun axis, and a drive for rotatably driving the carrier device about the sun axis at a sun rotational speed. A first planetary grinding station includes a first grinding vessel receiving device for a grinding vessel fillable with material to be ground and grinding media. The receiving device and grinding vessel are mounted on the carrier device and are rotatable about a first planetary axis of rotation, eccentrically with respect to the sun axis. A drive rotatably drives the receiving device with the grinding vessel about the first planetary axis of rotation at a first planetary rotational speed.

### TECHNICAL FIELD

The present disclosure relates to a planetary mill, in particular on the laboratory scale, for comminuting material to be ground, in which a grinding vessel revolves around a sun axis on a planetary orbit and at the same time rotates about at least one or more planetary axes of rotation, in order to finely comminute the material to be ground in the interior of the grinding vessel, in particular with the aid of grinding media, e.g. grinding balls.

### BACKGROUND OF THE PRESENT DISCLOSURE

Planetary mills on the laboratory scale are used for example in process analytics for grinding samples. Planetary mills, sometimes also referred to as ball mills or planetary ball mills, are described for example in the patent applications DE 197 12 905 A1, DE 10 2006 006 529 A1, DE 10 2006 018 325 A1, DE 10 2006 047 481 A1, DE 10 2006 047 480 A1, DE 10 2006 047 479 A1 and DE 10 2006 047 498 A1. Newer planetary mills are described for example in DE 10 2010 044 254 A1, DE 10 2012 009 983 A1, DE 10 2012 009 985 A1, DE 10 2012 009 982 A1, DE 10 2012 009 984 A1, DE 10 2012 009 987 A1. An overview of planetary mills on the laboratory scale that are currently commercially available can furthermore be found on the applicant's website under www.fritsch.de.

In the case of planetary (ball) mills, grinding cups are arranged, as planets, eccentrically with respect to a sun axis, sometimes also referred to as a central axis, and on the one hand revolve around the sun axis on a circular path, and on the other hand rotate about their own axis, the eccentric planetary axis of rotation. Typically, in the case of a planetary mill, the sun axis and the planetary axis of rotation extend in parallel. Due to the revolution and the rotation of the grinding cups, a changing radially outwardly directed centrifugal force is exerted on the material to be ground that has been poured into the grinding cup. Typically, grinding media, for example grinding balls, are also added to the material to be ground, which grinding media comminute the material to be ground in a highly efficient manner by an impact and friction effect.

In the case of certain dimensions of the revolving parts and certain rotational speeds, trajectories for the material to be ground and the grinding media can be created in a planetary ball mill. The material to be ground and the grinding media then move transversely through the grinding cup until the strike the inside wall of the grinding cup. Thereafter, the material to be ground together with the grinding media can be carried along a little on the inside periphery of the grinding cup, until the resulting force again ensures that the transverse acceleration, described above, takes place and the material to be ground and the grinding media perform a flying movement through the grinding cup. This is also referred to as a “throwing regime”. If a ball mill operates in the throwing regime, at high rotational speeds a particularly high grinding effect can possibly be achieved.

Planetary ball mills are in any case characterized by quick and effective communition. They can be used in a versatile manner and are ideal for loss-free micro-comminution up to final finenesses in the nanometer range. Depending on the task, the grinding can be performed dry, in suspension, or under protective gas. They are also very well suited for homogenization of emulsions and pastes or for mechanical alloying in materials research. Such nano-comminution requires a relatively high input of energy.

A planetary ball mill is known from U.S. Pat. No. 7,744,027 B2, in which the cups revolve in a ring made of resilient material at the upper end of the cup, and are clearly caused to rotate in a frictionally engaged manner by friction between the cups and the revolving resilient ring. In this case, the cups are tilted in the direction of the central axis of rotation, wherein the planetary ball mill can have an oscillation mechanism, in order to generate an oscillating movement of the cup in that the angle of inclination of the rotation can change during the revolution. For this purpose, an elliptical ring is used, and the suspension comprises a hinge. In each case, the axes of rotation intersect and are always coplanar in a common plane, such that the effect of the dynamic forces, which act on the cup content in the event of the planet movement, in principle does not differ from the planetary ball mills described at the outset. The drive furthermore appears to require improvement with respect to the reliability, and probably exhibits slippage and a high degree of wear. It is assumed that there is no synchronicity and that the rotational speeds and the performance are very limited in practice.

### GENERAL DESCRIPTION OF THE PRESENT DISCLOSURE

The object of the present disclosure is that of providing a novel planetary mill, in particular having novel design and dynamic parameters.

A further aspect of the object is that of providing a planetary mill which has high grinding performance and/or by means of which a quick grinding result can be achieved.

A further aspect of the object is that of providing a planetary mill in which, during operation, a significant friction and optionally impact effect can be achieved between the particles of material to be ground and/or between the material to be ground and grinding media, e.g. grinding balls.

A further aspect of the object is that of providing a planetary mill which has a varied selection and adjustment possibilities with respect to its design and dynamic parameters, and which can be flexibly adapted to different grinding tasks.

A further aspect of the object is that of providing a planetary mill which is smooth-running, low-wear, robust, and cost-effective.

The object of the present disclosure is achieved by the subject matter of the independent claims. Additional developments of the present disclosure are defined in the dependent claims.

The planetary mill for comminuting material to be ground comprises a carrier device which is mounted so as to be rotatable about a sun axis, sometimes also referred to as a central axis, and the rotation of which about the sun axis, at a sun rotational speed US, is driven by a drive. For example, the drive of the carrier device, or sun drive, can be a belt drive that is driven by an electric drive motor. Maximum rotational speeds, by way of example, of the carrier device can, without limiting the generality, be for example in the range between 200 min⁻¹ or 400 min⁻¹ and 1100 min⁻¹ or more, e.g. 1500 min⁻¹ or 1800 min⁻¹. The carrier device can for example comprise a round sun disc.

In particular in the case of a laboratory planetary mill, which is configured for example with respect to size and weight in such a way that it can be placed, in a laboratory, for example on a rack, a table, a cabinet, or the like, said mill preferably comprises a device housing, in which the rotating parts of the planetary mill, electronics, and/or the drive motor, can be accommodated. A device housing of this kind preferably comprises a closure lid which allows access to the planetary grinding station(s), in particular to the grinding vessel(s), when the device housing is open, and closes the device housing, in accordance with safety regulations, during operation, i.e. in the case of rotation of the carrier device and/or further components in the device housing.

Furthermore, a base plate may be included, e.g. as a base plate of the device housing, wherein a sun axis end is fastened to the base plate, on which in turn the carrier device is rotatably mounted, and which thus defines the sun axis.

The planetary mill further comprises a first planetary axis of rotation and a first planetary grinding station having a first grinding vessel receiving device for at least one grinding vessel that can be filled with the material to be ground and grinding media, e.g. grinding balls. Accordingly, the first grinding vessel receiving device is mounted on the carrier device so as to be rotatable about the first planetary axis of rotation, eccentrically with respect to the sun axis, i.e. offset radially towards the outside, such that the first grinding vessel receiving device together with the grinding vessel is carried along by the carrier device on a planetary orbit around the sun axis and at the same time rotates about the eccentric planetary axis of rotation, when the carrier device rotates about the sun axis. Thus, the first grinding vessel receiving device, which accordingly can also be referred to as the planetary grinding vessel receiving device, together with the (planetary) grinding vessel, performs a combined orbital movement and rotation about its own axis, which leads to particular dynamic conditions for the material to be ground and optionally the grinding media inside the grinding vessel.

The grinding vessel preferably comprises a grinding cup and a detachable grinding cup lid, by means of which the grinding vessel can be closed by the user for the grinding process or can be opened before and after the grinding process, in order to pour in the material to be ground and optionally the grinding media, and to remove the finely ground material to be ground after the grinding process. The grinding vessels of a laboratory mill of this kind can have an internal volume (size) e.g. in the range of 10 ml to 1000 ml, preferably in the range of 50 ml to 500 ml.

The planetary mill comprises a first planetary grinding station, i.e. at least one planetary grinding station, but can also comprise a plurality of identical planetary grinding stations, e.g. 2 (duo mill), 3 (triple mill), 4 (quattro mill), or more identical planetary grinding stations, as can be seen from the embodiments.

The planetary mill further comprises a planetary drive for rotatably driving the first grinding vessel receiving device together with the grinding vessel about the first planetary axis of rotation at a first planetary rotational speed (UP1). The planetary drive can be formed by a synchronous drive, e.g. by a toothed belt drive, which is driven by the rotation of the carrier device. However, other drive forms, preferably other synchronous drives, are also conceivable. Thus, as a result of the combined sun rotation of the carrier device and the planetary rotation, during operation the first planetary grinding station comprising the first grinding vessel receiving device and the grinding vessel revolves around the sun axis on the planetary orbit, at the sun rotational speed US, and at the same time the first grinding vessel receiving device together with the grinding vessel rotates about the first planetary axis of rotation, at the planetary rotational speed UP.

According to one aspect of the present disclosure, the first planetary axis of rotation extends in a skewed manner relative to the sun axis, at least at times, during the rotation. According to a general definition, two axes or straight lies extend in a skewed manner relative to one another when they neither intersect nor are in parallel with one another in three-dimensional space. The rotation vectors of the sun rotation and the planet rotation about the first planetary axis of rotation accordingly are not in the same plane.

In other words, the first planetary axis of rotation at least at times does not extend in parallel with the sun axis, and is at least not permanently in one plane with the sun axis. It is therefore the case during the rotation, at least most of the time, preferably permanently, that the first planetary axis of rotation and the sun axis do not intersect and do not extend in parallel.

In other words, the first planetary axis of rotation P1 does not intersect the sun axis S more than temporarily at singular timepoints, and otherwise extends in a skewed manner relative to the sun axis S.

For example, the first planetary axis of rotation can extend in parallel with the rotation plane of the carrier device.

A highly complex dynamic movement of the grinding vessel can be produced thereby.

Specifically, as a result, in three-dimensional space a further dynamic direction component can be added into the temporally quickly changing force factor, which acts on the material to be ground and optionally the grinding media during the complex combined orbital movement and planetary rotation of the grinding vessel, and thus brings about the grinding of the material to be ground by means of a frictional and/or impact effect relative to the grinding vessel wall. In particular, further particular dynamic force components in the normal direction (Z direction) perpendicular to the rotation plane (X-Y plane) can be added to the otherwise prevailing forces in the two-dimensional rotation plane of the carrier device (X-Y plane). Although force components in the Z direction may possibly occur, in the case of inwardly inclined cups, these are unlikely to be comparable with a planetary rotation about a planetary axis of rotation that is skewed with respect to the sun axis, i.e. the rotation vectors of the sun rotation and the planetary rotation are not in the same plane.

Hitherto, this could mean unforeseen possibilities for the dynamics in the grinding vessel of a planetary mill.

In this respect, a toothed belt drive for driving the planetary rotation about the first planetary axis of rotation is preferred. A toothed belt drive on the one hand operates in a slippage-free manner, and on the other hand has a certain flexibility, which can be desirable with respect to the forces occurring in the case of these specific dynamics.

Preferably, the size of the grinding vessel and the eccentric positioning of the first planetary grinding station with respect to the sun axis, i.e. the radial offset of the first planetary grinding station with respect to the sun axis, are selected in such a way that the sun axis does not intersect the interior of the grinding vessel, or intersects it only in a peripheral edge region. This can be desirable with respect to the dynamics or the forces on the material to be ground and optionally the grinding media, and thus on the grinding effect.

The rotation of the carrier device about the sun axis can for example be brought about by means of a sun belt drive, which is driven by a drive motor, e.g. a commercially available electric motor. For example, the carrier device comprises a sun disc, which can comprise a belt groove for engagement of the belt. The sun belt drive can even be configured as a simple fan belt drive, since at this point synchronicity is not essential. However, a toothed belt drive or another transmission form should not be excluded.

Now at least two groups of embodiments are possible, in particular first embodiments in which the planet or the grinding vessel receiving device together with the grinding vessel, in addition to the orbital movement about the sun axis, rotates only about just one planetary axis of rotation, which extends in a skewed manner relative to the sun axis, and in particular second embodiments in which the planet or the grinding vessel receiving device together with the grinding vessel, in addition to the orbital movement about the sun axis, rotates about at least two different planetary axes of rotation, of which at least one extends in a skewed manner relative to the sun axis. Thus, in the first embodiments, the just one planetary axis of rotation is quasi rotated in such a way that it is skewed relative to the sun axis, and in the second embodiments at least one further planetary rotation about at least one further other planetary axis of rotation is added, wherein at least one of the planetary axes of rotation is skewed relative to the sun axis and/or preferably not in parallel with the other planetary axis of rotation. Furthermore, the possibility of further planetary rotations about further planetary axes of rotation, e.g. a third and/or fourth and or further planetary axes of rotation, being provided should not be excluded.

Thus, in the first embodiments, during operation the first grinding vessel receiving device together with the grinding vessel revolves around the sun axis on the planetary orbit about just one single planetary axis of rotation, specifically the first planetary axis of rotation. In this case, the first planetary axis of rotation in particular extends constantly in a skewed manner relative to the sun axis, such that the first planetary axis of rotation in particular does not intersect the sun axis at any time during the rotation.

In this case, the first planetary axis of rotation preferably extends in parallel with the rotation plane of the carrier device, which is relatively simple to achieve in structural terms, with respect to the planetary drive.

Further preferably, the first planetary axis of rotation is located, in particular permanently, transversely or perpendicularly to the radius r_{P} of the planetary orbit, referred to for short as sun radius, of the first planetary grinding station around the sun axis. In other words, the first planetary axis of rotation preferably extends tangentially to the planetary orbit, which is also relatively simple to achieve in structural terms, with respect to the planetary drive.

Preferably, the planetary rotation of the first grinding vessel receiving device is driven synchronously to the rotation of the carrier device. Accordingly, a first planetary synchronous drive is provided between the carrier device and the first planetary grinding station, wherein the first planetary synchronous drive drives the rotation of the grinding vessel receiving device about the first planetary axis of rotation, synchronously to the rotation of the carrier device. The first planetary synchronous drive preferably comprises a first planetary toothed belt drive for driving the rotation of the grinding vessel receiving device about the first planetary axis of rotation. Thus, a fixed and reproducible rotational speed ratio can be specified, in structural terms.

The first planetary toothed belt drive preferably comprises a drive toothed belt pulley and an output toothed belt pulley. The drive toothed belt pulley is in particular rigidly connected to the stationary sun axis end, wherein during rotation of the carrier device, the output toothed belt pulley is carried along by the carrier device on a planetary orbit around the sun axis and is thereby caused to rotate by the first planetary toothed belt drive. This drive type is desirable inter alia with respect to resiliency and service life of the planetary drive.

Preferably, the relative rotational speed ratio between the rotation of the first grinding vessel receiving device, together with the grinding vessel, about the first planetary axis of rotation P1, and the rotation of the carrier device about the sun axis S, is, according to amount, in the range between 10:1 and 0.5:1, preferably between 5:1 and 1:1. In these ranges, despite the unusual dynamic conditions, inter alia the establishment of a throwing regime can be expected.

According to the second embodiment, the first planetary grinding station comprising the first grinding vessel receiving device and the grinding vessel is mounted on the carrier device, eccentrically with respect to the sun axis, i.e. offset radially towards the outside, so as to be rotatable about yet another further second planetary axis of rotation, in addition to the first planetary axis of rotation.

Accordingly, a second planetary drive for rotatably driving the first planetary grinding station, comprising the first grinding vessel receiving device and the grinding vessel, about the second planetary axis of rotation at a second planetary rotational speed UP2, is also included, such that during operation of the planetary mill the first planetary grinding station comprising the first grinding vessel receiving device and the grinding vessel revolves around the sun axis on the planetary orbit, and at the same time the first grinding vessel receiving device together with the grinding vessel rotates about the first and at the same time about the second planetary axis of rotation. This type of threefold rotation, i.e. sun rotation and planetary rotation about at least two different or linearly independent planetary axes of rotation, can also be referred to as 3D planetary rotation. Therefore, this planetary mill is also referred to here as a 3D planetary mill.

It is to be expected that particular dynamics of the force introduction onto the material to be ground and optionally the grinding media can be achieved thereby. The movement, to be expected, of the material to be ground and optionally the grinding media inside the grinding vessel interior, relative to the grinding vessel wall, can possibly even be considered a chaotic movement.

In particular, the first and second planetary axis of rotation do not extend in parallel with one another. As a result the direction of the first planetary axis of rotation changes during the rotation about the second planetary axis of rotation, relative to the sun axis and/or relative to the laboratory system or device housing.

For example, the first and second planetary axis of rotation extend perpendicularly to one another.

In the case of an arrangement that is still relatively simple to achieve in structural terms, the first planetary axis of rotation extends, in particular permanently, in parallel with the rotation plane of the carrier device (sun plane), and/or the second planetary axis of rotation extends, in particular permanently, so as to be offset in parallel relative to the sun axis. In other words, the second planetary axis of rotation is positioned perpendicularly on the carrier device, and/or the first planetary axis of rotation is located horizontally, i.e. in parallel with the sun plane.

Preferably, the first and second planetary axis of rotation intersect at a point located eccentrically with respect to the sun axis, within the first planetary grinding station, in particular within the grinding vessel, i.e. in a manner radially offset with respect to the sun axis. In this case, the intersection point of the first and second planetary axis of rotation thus defines the center of the planet, about which the grinding vessel receiving device together with the grinding vessel rotates about two different planetary axes of rotation. Preferably, the intersection point is located at a predefined height h, preferably a few centimeters to a few tens of centimeters, above the carrier device or the sun disc.

The first grinding vessel receiving device is preferably suspended in a gimballed manner on the carrier device or in the first planetary grinding station, in order to allow a simultaneous rotation about the first and second planetary axis of rotation, i.e. about both planetary axes of rotation. In this case, the two gimballed rotations can be driven either at the same or at a different rotational speeds.

In other words, the first grinding vessel receiving device is mounted in a gimballed manner on the carrier device or in the first planetary grinding station, so as to be rotatable about the first and second planetary axis of rotation, wherein the gimballed mounting of the first grinding vessel receiving device is arranged as a planet, eccentrically with respect to the sun axis. The first grinding vessel receiving device together with the grinding vessel is driven, in addition to the orbital movement of the first planetary grinding station or the planet around the planetary orbit, so as to rotate at a first planetary rotational speed UP1 about the first planetary axis of rotation and at the same time at a second planetary rotational speed UP2 about the second planetary axis of rotation.

According to one embodiment, the first planetary grinding station can comprise a retaining device, preferably on both sides, having a first pivot bearing, preferably on both sides, for the grinding vessel receiving device, wherein the first pivot bearing, which is preferably on both sides, defines the first planetary axis of rotation. Further preferably, the first planetary grinding station can comprise a second planetary shaft which can be rigidly connected to the planetary grinding station, e.g. at its underside. Further preferably, the carrier device can comprise a second pivot bearing in the region of the first planetary grinding station, which pivot bearing defines the second axis of rotation, in such a way that the first planetary grinding station is rotatably mounted in the carrier device by means of the second planetary shaft, concentrically with respect to the second planetary axis of rotation, wherein the rotation about the second planetary shaft thus defines the second planetary axis of rotation. Thus, the grinding vessel receiving device is mounted on the carrier device in a gimballed manner, eccentrically with respect to the sun axis, and can be driven, in operation, so as to rotate about the first and the second planetary axis of rotation.

The drive of the planetary rotation about one or preferably about both planetary axes of rotation P1, P2 preferably takes place synchronously with respect to the sun rotation. For this purpose, the planetary mill preferably comprises a first and/or a second planetary synchronous drive, wherein the first planetary synchronous drive drives the rotation of the grinding vessel receiving device about the first planetary axis of rotation, synchronously to the rotation of the carrier device, and/or the second planetary synchronous drive drives the rotation of the grinding vessel receiving device about the second planetary axis of rotation, synchronously to the rotation of the carrier device. For this purpose, a first and/or second planetary toothed belt drive for driving the rotation of the grinding vessel receiving device about the first and/or second planetary axis of rotation is preferred.

Thus, according to one embodiment, the first planetary synchronous drive is configured as a first planetary toothed belt drive and comprises a drive toothed belt pulley and an output toothed belt pulley. The drive toothed belt pulley is preferably rigidly connected to the carrier device in the region of the rotating first planetary grinding station, e.g. coaxially to the second planetary shaft, which can be configured for example as a shaft extension, mounted (by rolling bearings) in the carrier device, on the underside of the planetary grinding station. Thus, during rotation of the first planetary grinding station the rotation of the grinding vessel receiving device together with the grinding vessel about the first planetary axis of rotation is driven by means of the first planetary (toothed belt) drive.

Thus, further preferably, the second planetary synchronous drive is configured as a second planetary toothed belt drive and comprises a drive toothed belt pulley and an output toothed belt pulley, wherein the drive toothed belt pulley can be rigidly connected to the stationary sun axis end. The output toothed belt pulley is preferably fastened to the first planetary grinding station and, during rotation of the carrier device, is carried along by the carrier device on the planetary orbit around the sun axis, and as a result the rotation of the first planetary grinding station about the second planetary axis of rotation is driven by the second planetary toothed belt drive.

The drive for rotatably driving the first grinding vessel receiving device together with the grinding vessel about the first planetary axis of rotation P1 at a first planetary rotational speed UP1 can thus be configured as a first toothed belt drive, and/or the drive for rotatably driving the first grinding vessel receiving device together with the grinding vessel about the second planetary axis of rotation P2 at a second planetary rotational speed UP2 can be configured as a second toothed belt drive. As a result, on the one hand synchronicity and on the other hand flexibility with respect to dynamic forces can be achieved.

Preferably, the 3D planetary mill thus comprises two toothed belt drives for the two rotational movements of the grinding vessel receiving device together with the grinding vessel about the two planetary axes of rotation P1 and P2. The second toothed belt drive, driven by the sun rotation of the carrier device, drives the rotation of the first planetary grinding station at the second planetary rotational speed UP2 about the second planetary axis of rotation P2. The first toothed belt drive, driven by the rotation of the first planetary grinding station, drives the rotation of the grinding vessel receiving device at the planetary rotational speed UP1 about the first planetary axis of rotation P1. The first toothed belt drive is preferably a restricted toothed belt drive, which rotates together with the first grinding station about the second planetary axis of rotation P2. The first toothed belt drive can comprise a horizontal drive toothed belt pulley (vertical axis of rotation), which can be rigidly connected to the carrier device, and a vertical output toothed belt pulley (horizontal axis of rotation), and a toothed belt drive deflection from the horizontal into the vertical, e.g. by means of at least one deflection roller. In other words, the rotation of the first planetary grinding station about the second planetary axis of rotation P2 drives the first toothed belt drive via the horizontal drive toothed belt pulley, which in turn converts the rotational movement about the vertical second planetary axis of rotation P2 into a rotational movement about the horizontal first planetary axis of rotation P1.

For a planetary mill having 3D rotation of the grinding vessel about the sun axis and about the two planetary axes of rotation, a relative rotational speed ratio between the rotation of the first grinding vessel receiving device, together with the grinding vessel, about the second planetary axis of rotation, and the rotation of the carrier device about the sun axis, which, according to amount (|UP2:US|), is in the range between 25:1 and 0.5:1, preferably between 5:1 and 1:1, has been demonstrated. The rotation direction of the sun rotation and of the first grinding vessel receiving device together with the grinding vessel, about the second planetary axis of rotation, can be synchronous or opposing, wherein opposing is preferred. Thus, UP2:US is preferably in the range between −25:1 and −0.5:1, preferably between −5:1 and −1:1, wherein the negative sign stands for opposing rotation directions. A rotational speed ratio between the rotation of the first grinding vessel receiving device, together with the grinding vessel, about the first planetary axis of rotation, and about the second planetary axis of rotation, which, according to amount (|UP1:UP2|), is in the range between 10:1 and 0.1:1, preferably in the range between 5:1 and 0.2:1, has further been found to be desirable.

The planetary mill has been described above on the basis of an example comprising one planet or one planetary grinding station (mono-planetary mill). However, the planetary mill according to the present disclosure can also comprise a further second (duo-planetary mill), third (triple planetary mill), fourth (quattro planetary mill), and/or further planetary grinding stations, which revolve around the sun axis on the planetary orbit (multi-planetary mill). In particular, the further planetary grinding stations are configured identically to the first planetary grinding station, such that corresponding repetitions can be omitted here. The further (planetary) grinding vessel receiving devices can also be driven to rotate about their own first and/or second planetary axis of rotation in each case. Typically, a duo- or quattro planetary mill are constructed symmetrically with respect to the sun axis, or all the planetary grinding stations revolve on the same planetary orbit (symmetrical multi-planetary mill). Preferably, in the case of a 3D multi-planetary mill, all the grinding vessel receiving devices, together with the respectively associated grinding vessels, rotate about their respectively associated second planetary axis of rotation opposingly to the sun rotation, in particular having the above-described rotational speed ratios.

According to one embodiment, the carrier device or the sun disc can in each case comprise recesses, on the planetary orbit, for receiving the planetary grinding station, such that the planetary grinding stations can rotate in a manner sunk into the sun disc at least in part, e.g. by the lower shaft extension. This type of planet mounting has proven itself.

The planetary mill has at least the following design and dynamic parameters:
a) the radius of the planetary orbit, sun radius for short, r_{P},
b) the planetary internal radius r_{V},
c) the ratio of the sun radius to the planetary internal radius r_{P}:r_{V},
d) the sun rotational speed US,
e) the first planetary rotational speed UP1 about the first planetary axis of rotation, optionally the second planetary rotational speed UP2 about the second planetary axis of rotation,
g) the ratio of the first planetary rotational speed to the sun rotational speed UP1:US, and/or
h) optionally the ratio of the second planetary rotational speed to the sun rotational speed UP2:US.

In this case, the eccentric offset of the first planetary grinding station with respect to the sun axis defines the sun radius r_{P} between the sun axis and the center point of the planetary grinding station. The grinding vessel comprises an interior for pouring in the material to be ground and the grinding media, and the interior defines the planetary internal radius r_{V}.

Preferably, one, a plurality of or all of these design and dynamic parameters of the planetary mill are selected such that, during operation of the planetary mill, the material to be ground and optionally the grinding media sometimes detach from the inside wall of the grinding vessel, move through the interior of the grinding vessel, and strike against the inside wall of the grinding vessel again.

It is to be assumed that, in particular due to the combination of the orbital movement around the sun axis and the first planetary rotation about a planetary axis of rotation that is skewed relative to the sun axis, and optionally also with addition of a further second planetary rotation about a further second planetary axis of rotation that can be, but does not have to be, in parallel with the sun axis, a specific movement regime with detachment of the material to be ground and optionally the grinding media from the inside wall of the grinding vessel can be produced, which—without claiming scientific correctness—can possibly even bring about a type of chaotic trajectories of the particles in the grinding vessel.

Preferably, the ratio of the planetary internal radius r_{V} to the sun radius r_{P} is in the range of 1:0.5 to 1:10, preferably in the range of 1:0.8 to 1:8, preferably in the range of 1:1 to 1:5.5, wherein the eccentric offset of the first planetary grinding station with respect to the sun axis defines the sun radius r_{P} between the sun axis and the center point of the planetary grinding station, and wherein the grinding vessel defines an interior for pouring in the material to be ground and the grinding media, and the interior defines a planetary internal radius r_{V}. The ratios allow for a good grinding effect and a suitable movement regime to be anticipated.

In the case of the (laboratory) planetary mill, the grinding vessel can in particular be detachably inserted into the respective grinding vessel receiving device, and the grinding vessel preferably comprises a grinding cup and a grinding cup lid that is detachable from the grinding cup, in order to be able to remove the grinding vessel from the planetary mill and to open it for filling with material to be ground and removing material to be ground. The grinding vessel preferably comprises a cylindrical, spherical or elliptical interior for pouring in the material to be ground and the grinding media. These vessel shapes have been found to be particularly suitable in connection with the particular dynamic ratios.

The external shape of the grinding vessel can be substantially cylindrical, irrespective of the shape of the interior, and defines a central grinding cup axis. The grinding vessel preferably includes a grinding cup having a grinding cup base that extends transversely to the grinding cup axis, and an annular grinding cup wall that is peripherally connected to the grinding cup base and extends axially from the grinding cup base. The grinding cup is open at its upper side that is axially opposite the grinding cup base. The external shape of the grinding cup may be largely U-shaped, in an axial cross section. The open upper side of the grinding cup forms an annular sealing surface, and the grinding cup is closed by a separate grinding cup lid which seals against the annular sealing surface of the grinding cup. The grinding cup lid extends transversely with respect to the grinding cup axis, and comprises a central region on the underside, which region forms the upper limit of the grinding vessel interior and a peripheral annular region surrounding the central region, which seals against the annular sealing surface of the grinding cup. Thus, during operation of the planetary mill the central region of the underside is in contact with the material to be ground and optionally the grinding media, whereas the peripheral annular region faces the annular sealing surface of the grinding cup.

According to another embodiment, the grinding vessel receiving devices are configured in such a way that different, optionally differently sized, grinding vessels can be exchangeably inserted into the grinding vessel receiving devices. Further preferably, the grinding vessel receiving devices each comprise a bracing device, in order to reliably brace the grinding cup, closed with the grinding cup lid, in the respective grinding vessel receiving device.

The first grinding station preferably comprises a retaining device and a first planetary shaft which is in parallel with the carrier device, i.e. extends horizontally, and which defines the first planetary axis of rotation and on which the first grinding vessel receiving device is fastened. The grinding vessel can be inserted into the first grinding vessel receiving device and braced therein. The first grinding vessel receiving device is mounted in the retaining device, by the horizontal first planetary shaft, so as to be rotatable about 360°, and can rotate freely in the retaining device, together with the grinding vessel braced in the first grinding vessel receiving device, driven at the first planetary rotational speed UP1.

According to one embodiment, the first grinding vessel receiving device comprises a clamping cage in which the grinding vessel can be braced, wherein the clamping cage in particular comprises the following:
a cage lower part, configured for insertion of the grinding vessel, wherein the cage lower part comprises an annular portion, a shell portion that is connected to the annular portion and extends axially from the annular portion, and a cage bottom which delimits the shell portion at the bottom, wherein the first planetary shaft is fastened to the annular portion,
a cage lid part for closing the clamping cage, wherein the grinding vessel can be inserted into the clamping cage and removed from the clamping cage when the clamping cage is open, and
a bracing device for bracing the grinding vessel (90) in the clamping cage when the clamping cage is closed.

The cage lid part is in particular detachably fastened to the cage lower part. This can be achieved by means of a closure, e.g. a bayonet closure.

The grinding vessel preferably includes a grinding cup having a grinding cup axis, and a grinding cup lid which is detachable from the grinding cup, in order to be able to pour material to be ground into the grinding cup and to remove it therefrom. The grinding cup lid can be axially braceable against the grinding cup by means of the bracing device when the grinding vessel is inserted into the clamping cage and the clamping cage is closed.

For this purpose, the bracing device preferably generates a clamping force which acts on the grinding vessel acts perpendicularly to the first planetary axis of rotation P1.

The present disclosure will be explained in greater detail in the following, on the basis of embodiments and with reference to the figures, wherein identical and similar elements are sometimes provided with the same reference signs, and the features of the different embodiments can be combined with one another.

### BRIEF DESCRIPTION OF THE DRAWINGS

In the drawings:

FIG. 1 is a schematic detail illustration of the design and dynamic parameters of a 3D planetary mill according to a model consideration,

FIG. 2 is a three-dimensional view of a 3D planetary mill according to one embodiment of the present disclosure, in the form of a mono 3D planetary mill,

FIG. 3 shows parts of the interior of the 3D planetary mill from FIG. 2,

FIG. 4 is a three-dimensional view, obliquely from above, of the carrier device and the planetary grinding station of the 3D planetary mill from FIG. 2,

FIG. 5 is a three-dimensional view, obliquely from below, of the carrier device of the 3D planetary mill from FIG. 2,

FIG. 6 is a sectional three-dimensional view of the carrier device and the planetary grinding station of the 3D planetary mill from FIG. 2,

FIG. 7 is a sectional view through the carrier device and the planetary grinding station of the 3D planetary mill from FIG. 2,

FIG. 8 is a three-dimensional view, obliquely from above, of the carrier device and the planetary grinding station of a planetary mill according to a further embodiment of the present disclosure,

FIG. 9 is a three-dimensional view, obliquely from below, of the carrier device according to FIG. 8,

FIG. 10 is a sectional three-dimensional view of the carrier device and the planetary grinding station according to FIG. 8,

FIG. 11 is a sectional view through the carrier device and the planetary grinding station according to FIG. 8,

FIG. 12 is a three-dimensional view of a 3D planetary mill according to a further embodiment of the present disclosure, as a duo 3D planetary mill,

FIG. 13 is a three-dimensional view, obliquely from above, of the carrier device and the two planetary grinding stations of the 3D planetary mill from FIG. 12,

FIG. 14 is a three-dimensional view, obliquely from below, of the carrier device and the two planetary grinding stations of the 3D planetary mill from FIG. 12,

FIG. 15 is a sectional three-dimensional view through parts of the interior of the 3D planetary mill from FIG. 12,

FIG. 16 is a sectional view through parts of the interior of the 3D planetary mill from FIG. 12,

FIG. 17 is a three-dimensional view of the carrier device comprising two grinding stations, according to a further embodiment of the present disclosure,

FIG. 18 is a cross-section through the carrier device and the grinding stations from FIG. 17,

FIG. 19 is a three-dimensional view of the cage lower part in a grinding station according to FIG. 17,

FIG. 20 is like FIG. 19, having the grinding vessel inserted,

FIG. 21 is a three-dimensional view of the closed clamping cage having a braced grinding vessel,

FIG. 22 is a three-dimensional view of the carrier device from FIG. 17 comprising alternative grinding vessels,

FIG. 23 is a cross-section through the carrier device and the grinding stations from FIG. 22.

### DETAILED DESCRIPTION OF THE PRESENT DISCLOSURE

For conventional planetary ball mills, calculations based on the conventional planetary ball mill PULVERISETTE 4 by the applicant are known from the publication “Contributions to The Modelling Of The Milling Process in a Planetary Ball Mill”, Gy. Kakuk¹, I, Zsoldos¹, Á. Csanády², I.Oldal¹, ¹Szent Istvan University, Faculty of Mechanical Engineering, H-2103 Pater Karoly Str. 1, Gödöllö, Hungary, ²Bay Zoltán Foundation, Institute of Material Science and Technology, H-1116, Fehervari Str. 130, Budapest, Hungary, Rev.Adv.Mater.Sci. 22(2009) 21-38. These publications are hereby incorporated by reference. Based on the theoretical models for a conventional (2D) planetary ball mill, on which this publication is based, new theoretical considerations were now undertaken, in order to study the complex dynamic ratio in a 3D planetary mill in accordance with the present disclosure. These theoretical considerations are set out in the following. They are based on theoretical assumptions, approximations and models, and make no claim to completeness and correctness, but may be helpful for understanding the complex dynamic grinding processes in a 3D planetary (ball) mill.

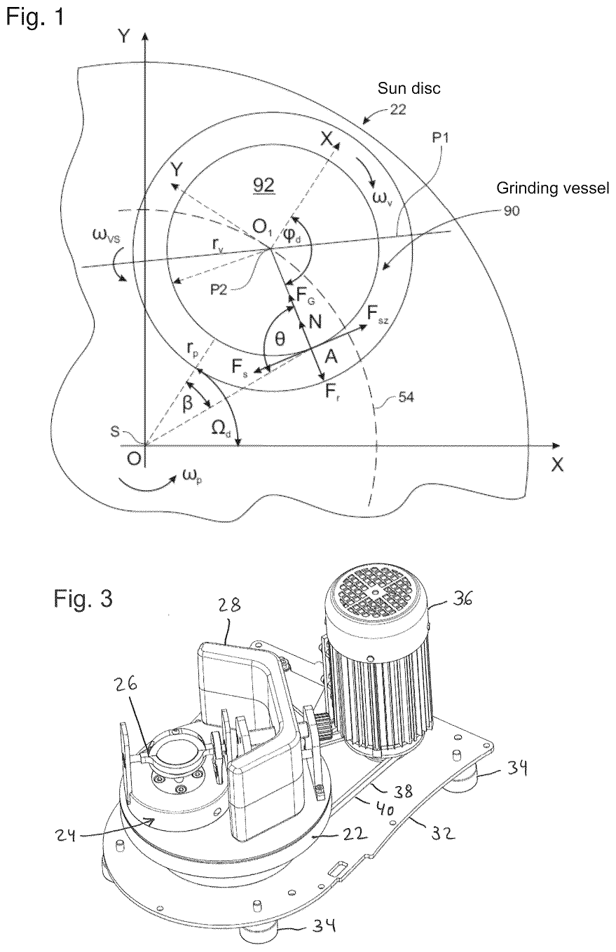

With reference to FIG. 1, in the following a model consideration with regard to a 3D planetary (ball) mill is set out.

### Grinding in a 3D Planetary Ball Mill

In a 3D planetary ball mill by way of example, compared with a conventional planetary ball mill a further (first) planetary axis of rotation P1 for the grinding vessel 90 or the grinding cup 91a, e.g. in the sun plane 52, in parallel with the X-direction, is introduced, in addition to the sun axis S and to the (second) planetary axis of rotation P2 extending in parallel with the sun axis S. The additional planetary axis of rotation P1 can be located for example at a height h above the carrier device 22, perpendicularly to the grinding vessel axis, through the grinding vessel center O₁, and the grinding vessel can rotate e.g. at the same rotational speed about the additional first planetary axis of rotation P1 as about the second planetary axis of rotation P2 through O₁. In this case, the grinding vessel 90 in the grinding vessel receiving device 26 is driven so as to rotate about the two planetary axes of rotation P1, P2, in a gimballed suspension that is arranged eccentrically around the radius r_{P} of the planetary orbit, referred to for short as sun radius r_{P}.

### Planet Movements and Force Ratios

With reference to FIG. 1, the forces acting on the grinding balls in the grinding cup are accordingly:
the centrifugal force from the center of the sun disc F_{sz}
the centrifugal force from the center of the grinding cup Fᵣ
the centrifugal force from the center of the grinding cup F_{rS}
(from the rotation about the first planetary axis of rotation)
the normal force N and the friction force Fₛ resulting from the interaction of grinding balls and grinding cup
the Coriolis forces F_{C} and F_{CS}
gravity

Taking account of the additional (first) planetary axis of rotation P1 perpendicular to the grinding cup axis through O₁, the following accelerations and forces result for the rotations about the first planetary axis of rotation P1 of the grinding cup. The Coriolis force acts in the case of movements in all directions which have at least one component perpendicular to the axis of rotation, and constantly causes a deflection to one side, since this force is always perpendicular to the current movement direction, on the disc.

$$\\ \begin{matrix}{\vec{a}}_{r} = {\vec{ω}}_{V 1} \times ( {\vec{v}}_{V} + {\vec{v}}_{VS} ) & a )\end{matrix}$$

$$\\ \begin{matrix}{a}_{r} = {ω}_{V} \cdot {r}_{V} \cdot \sqrt{{ω}_{V}^{{}_{} 2} + {ω}_{VS}^{{}_{} 2}} & b )\end{matrix}$$

$$\\ \begin{matrix}{\vec{a}}_{C} = 2 \cdot {\vec{ω}}_{P} \times ( {\vec{v}}_{V} + {\vec{v}}_{VS} ) & c )\end{matrix}$$

$$\\ \begin{matrix}{a}_{C} = 2 \cdot {ω}_{P} \cdot {r}_{V} \cdot \sqrt{{ω}_{V}^{{}_{} 2} + {ω}_{VS}^{{}_{} 2}} & d )\end{matrix}$$

The single forces acting follow from the sum of the forces within the system

$$\\ \begin{matrix}{F}_{r} = {m}_{b} \cdot {r}_{V} \cdot {ω}_{V} \cdot \sqrt{{ω}_{V}^{{}_{} 2} + {ω}_{VS}^{{}_{} 2}} & a )\end{matrix}$$

$$\\ \begin{matrix}{F}_{C} = 2 \cdot {m}_{b} \cdot {ω}_{P} \cdot {r}_{V} \cdot \sqrt{{ω}_{V}^{{}_{} 2} + {ω}_{VS}^{{}_{} 2}} & b )\end{matrix}$$

### Separation Angle

Thus, the separation condition changes to:

$$\\ \begin{matrix}{m}_{b} \cdot {ω}_{P}^{{}_{} 2} \cdot \frac{{r}_{P} + {r}_{V} \cdot cos {φ}_{d}}{cos β} \cdot cos ( π - θ ) + 2 \cdot {m}_{b} \cdot {r}_{V} \cdot {ω}_{P} \cdot \sqrt{{ω}_{V}^{{}_{} 2} + {ω}_{VS}^{{}_{} 2}} = {m}_{b} \cdot {r}_{V} \cdot {ω}_{V 1} \cdot \sqrt{{ω}_{V}^{{}_{} 2} + {ω}_{VS}^{{}_{} 2}} & a )\end{matrix}$$

or for ω_{V}=ω_{VS}

$$\\ \begin{matrix}{m}_{b} \cdot {ω}_{P}^{{}_{} 2} \cdot \frac{{r}_{P} + {r}_{V} \cdot cos {φ}_{d}}{\sqrt{2} \cdot cos β} \cdot cos ( π - θ ) + 2 \cdot {m}_{b} \cdot {r}_{V} \cdot {ω}_{P} \cdot {ω}_{V} = {m}_{b} \cdot {r}_{V} \cdot {ω}_{V}^{{}_{} 2} & b )\end{matrix}$$

### The Influence of the Ratio (i) on the Separation Angle and on the Grinding Ball Path (Movement Regime)

Although the sequence of rotations in general may not be changed, the commutativity of addition exists in the case of the angular speed. Thus, the sequence in which the components of the angular speed or entire angular speed vectors are added should not be important. The working range of a 3D planetary ball mill (iₗᵢₘᵢₜ≤i≤i_{kritisch}) is thus shifted in the direction of a friction regime by the additional rotation of the grinding cup about the additional first planetary axis of rotation P1. The transmission ratio can be modelled as follows:

$$\\ \begin{matrix}i = \frac{{ω}_{V}}{{ω}_{P}} & a )\end{matrix}$$

changes for ω_{V}=ω_{VS} to

$$\\ \begin{matrix}i = \frac{\sqrt{{ω}_{V}^{{}_{} 2} + {ω}_{VS}^{{}_{} 2}}}{{ω}_{P}} = \frac{\sqrt{2} \cdot {ω}_{V}}{{ω}_{P}} & b )\end{matrix}$$

$$\\ \begin{matrix}{φ}_{d} = arc cos ( - \frac{{r}_{V} \cdot {( 1 - i )}^{2}}{{r}_{P}} ) & c )\end{matrix}$$

wherein ω_{P} is the angular speed of the rotation of the carrier device 22 or sun disc about the sun axis S, ω_{VS} is the angular speed of the planet rotation about the first planetary axis of rotation P1 (which extends in a skewed manner relative to the sun axis at least at times or most of the time), and ω_{V} is the angular speed of the planet rotation about the second planetary axis of rotation P2 extending in parallel with the sun axis.

Thus, in the case of otherwise identical geometric ratios, it can be seen on the basis of the above model calculations that the friction regime can be achieved even at smaller transmission ratios than in a conventional 2D planetary ball mill. It is therefore to be expected that the grinding result can be influenced in an desirable manner by the additional rotation of the grinding cup about an additional planetary axis of rotation P1 located perpendicularly to the “usual” planetary axis of rotation P2. In the case of a vectorial consideration, this is also to be expected for other planetary axes of rotation P1 positioned in a skewed manner relative to the sun axis.

### Speed at the Separation Point

In the case of a conventional 2D planetary ball mill, the grinding cup performs a rotational movement about the Z-axis.

$$\\ \begin{matrix}{R}_{z} ( φ ) = ( \begin{matrix}cos ( φ ) & - sin ( φ ) & 0 \\ sin ( φ ) & cos ( φ ) & 0 \\ 0 & 0 & 1\end{matrix} ) & a )\end{matrix}$$

In the case of the 3D planetary ball mill, the grinding cup performs additional, permanently changing, rotational movements about the X-axis and the Y-axis.

$$\\ \begin{matrix}{R}_{x} ( φ ) = ( \begin{matrix}1 & 0 & 0 \\ 0 & cos ( φ ) & - sin ( φ ) \\ 0 & sin ( φ ) & cos ( φ )\end{matrix} ) & a )\end{matrix}$$

$$\\ \begin{matrix}{R}_{y} ( φ ) = ( \begin{matrix}cos ( φ ) & 0 & sin ( φ ) \\ 0 & 1 & 0 \\ - sin ( φ ) & 0 & cos ( φ )\end{matrix} ) & b )\end{matrix}$$

Cf. https://de.wikipedia.org/wiki/Drehmatrix

The resulting separation speed (v_{d}) at the point “A” results from the sum of the circumferential speed of the sun disc (v_{dP}) and the circumferential speeds from the rotation of the grinding cup and its components in the X, Y and Z direction, as

$$\\ \begin{matrix}{v}_{d} = \sqrt{{v}_{dx}^{{}_{} 2} + {v}_{dy}^{{}_{} 2} + {v}_{dz}^{{}_{} 2}} & a )\end{matrix}$$

The circumferential speed is increased by the rotation about the additional (first) planetary axis of rotation P1 perpendicular to the grinding cup axis through O₁.

### Conclusion

In the case of a 3D planetary ball mill, the grinding conditions are influenced by the rotation about the additional (first) planetary axis of rotation P1. The separation point and separation angle are changed, such that a different movement regime results in a 3D planetary ball mill. At the same time, the separation speed and thus all following parameters such as the kinetic energy of the grinding balls at the impact point, the speed at the impact point, and consequently the impact energy and the grinding performance, are changed. The above consideration is based on a 3D planetary mill having two planetary axes of rotation P1, P2, of which one planetary axis of rotation is offset in parallel (P2) with respect to the sun axis S, and one planetary axis of rotation (P1) extends in parallel with the rotation plane 52 and in a skewed manner with respect to the sun axis S, at least most of the time. However, it is assumed that particular dynamic ratios can also already be achieved, at least in part, with just one single planetary axis of rotation P1 which extends in a skewed manner relative to the sun axis S.

In particular in the case of grinding cups 91a which are not spherical in the interior, i.e. for example in the case of cylindrical or elliptical grinding cup interiors 92, it is to be expected that the separation and impact points permanently change depending on ω_{VS}, and no longer follow a harmonic sine or cos function. Associated therewith, chaotically changing trajectories and speed vectors are expected, and therefore the movement regime should also change constantly.

On account of the good mixing which is to be assumed in this connection, a grindability limit, in the case of dry grinding, in the fine range is to be expected. It can also be assumed that the homogenization of the material to be ground can be in various ranges due to the energy input of the grinding balls.

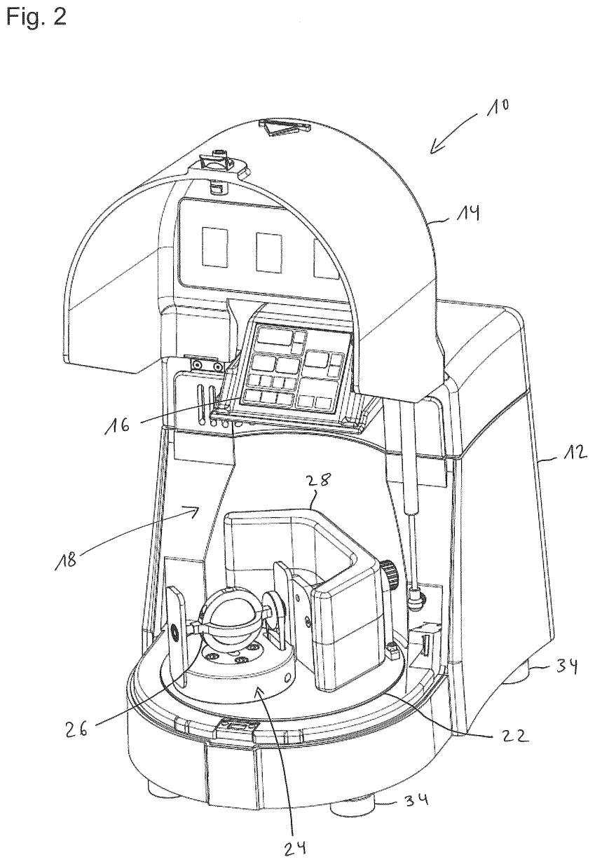

With reference to FIG. 2, the planetary mill 10, on the laboratory scale, comprises a device housing 12 having a housing cover 14, and an input means 16 for controlling the planetary mill 10, control panel 16 for short, for user input of operating parameters, including e.g. the speed of rotation. The housing cover 14 is shown in the open state, and in the present example can be closed and optionally locked by folding downwards, in order to ensure reliable release for operation of the planetary mill 10. When the device cover 14 is closed, the inner working space 18, in which the moving parts of the planetary mill 10, such as the carrier device 22, the planetary grinding station 24 and the grinding vessel receiving device 26 rotate, is closed, in order to meet safety requirements for a laboratory mill.

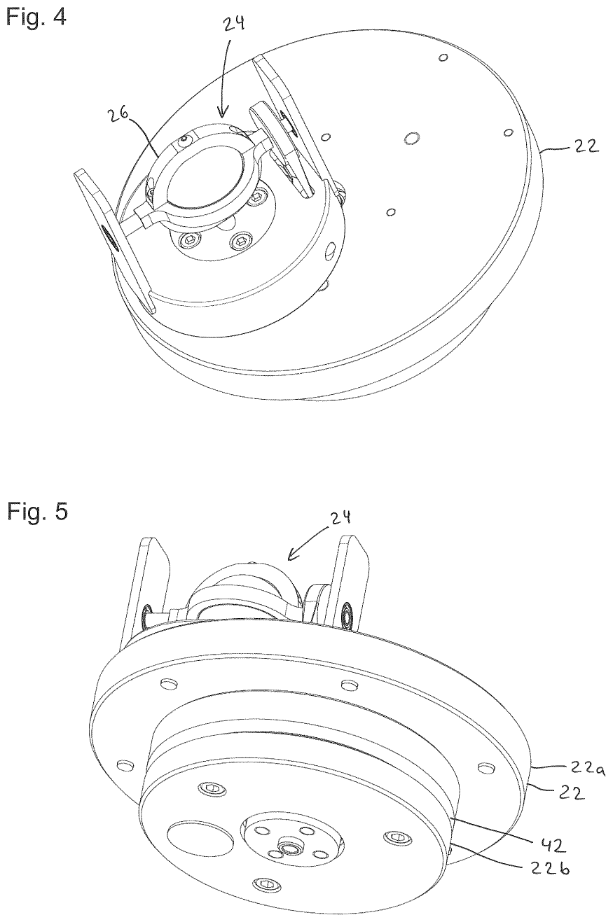

The (laboratory) planetary mill 10 shown in FIGS. 2 to 7 is a mono-planetary mill 10 comprising just one single planetary grinding station 24 and a radially adjustable counterweight 28 for compensating the imbalance of the just one planetary grinding station 24.

The device housing 12 is closed at its underside by a base plate 32 (cf. FIG. 3). The base plate 32 can comprise feet 34 on its underside, by means of which feet the planetary mill 10 can be erected on a laboratory bench (not shown) or the like in a laboratory.

The rotation about all available axes of rotation, i.e. in this example about the sun axis S, about the first planetary axis of rotation P1, and about the second planetary axis of rotation P2, is driven by the same primary drive 38, e.g. comprising an electric drive motor 36. In the present example, the primary drive 38 of the carrier device 22 is implemented by the electric drive motor 36, which drives a fan belt 40, which in turn drives the carrier device 22 in rotation.

The carrier device 22 is configured for example as a round sun disc having an upper cover disc 22a and a lower pulley 22b as an output disc of the primary drive 38. The output disc 22b is driven by the primary drive 38 to rotate about the sun axis S. In the present example, the output disc 22b comprises a fan belt groove 42 for the fan belt 40 of the primary belt drive 38, for driving the carrier device 22 about the sun axis S.

The carrier device 22 is rotatably mounted on a sun axis end 46, for example by means of ball bearings 44, wherein the sun axis end 46 is fastened to the base plate 32, e.g. screwed thereto, i.e. is stationary in the laboratory system. Driven by the primary drive 38, the carrier device 22 rotates, in the laboratory system, about the sun axis S or about the sun axis end 46.

A drive wheel 48 for the planetary rotary drive 50, in the present example in the form of a toothed belt drive 50, is fastened to the sun axis end 46. When the carrier device 22 rotates, the planetary grinding station 24, carried along by the carrier device 22, revolves around the sun axis S on the planetary orbit 54. The planetary grinding station 24 comprises a shaft extension 56 in the lower region, which shaft extension is mounted in the carrier device 22 so as to be rotatable about the planetary axis of rotation P2, for example by means of a ball bearing 58. Driven by the revolution of the planetary grinding station 24 about the sun axis S, the planetary drive 50 drives the rotation of the shaft extension 56 or the planetary grinding station 24 about the second planetary axis of rotation P2, via a drive wheel 60 fastened to the shaft extension 56. The use of a toothed belt drive (comprising a drive toothed belt pulley 48, an output toothed belt pulley 60, and a toothed belt 62) as a planetary rotary drive 50 for the planetary grinding station 24 ensures the synchronicity of the rotations of the planetary grinding station 24 about the planetary axis of rotation P2 with respect to the rotation of the carrier device 22 about the sun axis S, such that a predefined rotational speed ratio is reliably ensured. At the same time, the toothed belt drive 50 has sufficient flexibility with respect to dynamic imbalance caused by chaotic movement of material to be ground.

A grinding vessel receiving device 26 or grinding vessel clamping device is mounted in the planetary grinding station 24 so as to be rotatable about a further (first) planetary axis of rotation P1. The rotation of the grinding vessel receiving device 26 about the first planetary axis of rotation P1 is brought about by means of a further planetary rotary drive 70 which, in the present example, is also configured as a belt drive, in particular as a toothed belt drive. For this purpose, a drive wheel or a drive toothed belt pulley 68 is fastened to the carrier device 22 in the region of the planetary grinding station 24, in this example coaxially to the shaft extension 56. The drive wheel 68 drives an output wheel or output toothed belt pulley 80, located transversely to the second planetary axis of rotation P2 and coaxially to the first planetary axis of rotation P1, via a toothed belt 72. In this example, the planetary drive 70 is configured as a restricted toothed belt drive comprising two deflection rollers 74. The grinding vessel receiving device 26 is mounted in the grinding station 24 so as to be rotatable about the first planetary axis of rotation P1, by means of a first planetary shaft 86 that extends transversely to the second planetary axis of rotation P2. In other words, the first planetary shaft 86, extending transversely to the second planetary axis of rotation P2 in the planetary grinding station 24, defines the planetary axis of rotation P1. The output toothed belt pulley 80 is fastened to a first planetary shaft 86 that is mounted horizontally, by means of ball bearings 82, in a retaining frame 84 of the planetary grinding station 24. The further planetary drive 70 for the planet rotation about the first planetary axis of rotation P1 is accordingly configured as an angle drive, in the present example as a 90° angle drive.

Thus, the rotation of the carrier device 22 about the sun axis S first drives the rotation of the planetary grinding station 24 about the second planetary axis of rotation P2, which in turn drives the rotation of the grinding vessel receiving device 26 about the first planetary axis of rotation P1, located transversely with respect to the second planetary axis of rotation P2, via the further planetary drive 70.

The rotation drive for the sun rotation about the sun axis S and the planetary rotation about the first and second planetary axis of rotation P1, P2 is accordingly constructed in series, wherein the primary drive 38 drives the sun rotation and thus the orbital movement of the grinding station 24 on the planetary orbit 54, wherein the orbital movement of the grinding station 24 on the planetary orbit 54 drives the rotation of the grinding station 24 about the second planetary axis of rotation P2, and wherein the rotation of the grinding station 24 drives the rotation of the grinding vessel receiving device 26 about the first planetary axis of rotation P1.

In the present example, the planetary grinding station 24 comprises a base element 66, on the underside of which the shaft extension 56, mounted in the carrier device 22, is fastened, e.g. screwed. Laterally on the base element 66, cantilevers extend upwards, as a retaining device 84, on both sides of the grinding vessel receiving device 26. The grinding vessel receiving device 26 is mounted on both sides, for example by means of ball bearings 82, in the retaining device 84 or between the cantilevers. The mounting of the first planetary shaft 86 on both sides by means of rolling or ball bearings 82 in the retaining frame 84 of the planetary grinding station 24 ensures a sufficient stability for receiving the forces that arise, even at high rotational speeds. However, if the dimensioning is sufficient, one-sided mounting is also possible.

In this example, the entire planetary grinding station 24 rotates about the second planetary axis of rotation P2. The grinding vessel receiving device 26 rotates, together with the grinding vessel 90 clamped therein, inside the planetary grinding station 24, about the first planetary axis of rotation P1. Accordingly, the grinding vessel 90 performs a two-fold planetary rotation about the two planetary axes of rotation P1 and P2.

In this example, the second planetary axis of rotation P2 extends perpendicularly to the second planetary axis of rotation P2 or in parallel with the rotation plane 52 of the carrier device 22, and in a manner offset in parallel with respect to the sun axis S1 and the first planetary axis of rotation P1, and thus only temporarily perpendicularly to the sun axis S. However, it is also conceivable to provide the first and/or second planetary axis of rotation P1, P2 with an inclination, as a result of which additional complexity can be introduced into the movement regime.

In this example, the grinding vessel receiving device 26 is suspended in a gimballed manner on the carrier device 22, and specifically so as to be rotatable about the shaft extension 56 and the first planetary shaft 86 that is transverse thereto or is mounted by the vertical mounting 58 in the carrier device 22 and the horizontal mounting 82 in the planetary grinding station 24.

In other words, in this example the grinding vessel receiving device 26 is mounted, in a gimballed suspension arranged eccentrically with respect to the sun axis S, so as to be rotatable about the first and second planetary axis of rotation P1, P2, in order to bring about a combined planetary triple rotation, i.e. sun rotation and biaxial planetary rotation.

In this embodiment, an inner and outer spherical grinding vessel 90 is clamped in the grinding vessel receiving device 26, wherein different clamping mechanisms can be used. The spherical grinding vessel 90 defines a spherical interior 92, into which the material to be ground (not shown here) and optionally grinding media, e.g. grinding balls, can be poured.

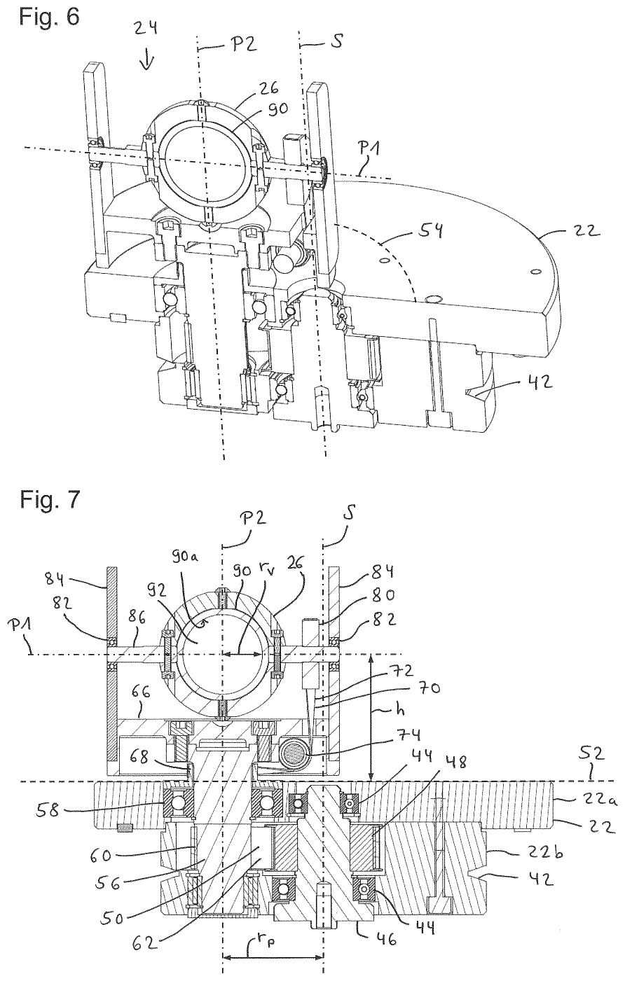

In summary, the grinding vessel receiving device 26 together with the grinding vessel 90 rotates, in addition to revolving on the planetary orbit 54, by means of the gimballed suspension, at a first planetary rotational speed UP1 about the first planetary axis of rotation P1 which, in the present example, is arranged in parallel with the rotation plane 52 of the carrier device 22, and at the same time at a second planetary rotational speed UP2 about the second planetary axis of rotation P2, which is vertical or is arranged in parallel with the sun axis S. It is clear that the first planetary axis of rotation P1 does not intersect the sun axis S apart from temporarily at singular timepoints (cf. FIGS. 6 and 7), i.e. extends (temporally) predominantly in a skewed manner with respect to the sun axis S, i.e. is not in parallel with the sun axis S and at least (temporally) predominantly does not intersect the sun axis. In other words, the first planetary axis of rotation P1 does not intersect the sun axis S more than temporarily at singular timepoints, and otherwise extends in a skewed manner relative to the sun axis S.

Due to the complex orbital and planetary rotation movement in three-dimensional space, caused by this, as set out above specific, possibly chaotic, dynamic ratios in the movement of the material to be ground and optionally the grinding media in the grinding vessel interior 92 are to be expected.

In the present example, the transmission ratio between the two planetary rotations about the planetary axes of rotation P1 and P2, i.e. UP1:UP2, is equal to 1. However, depending on the grinding task other rotational speed ratios UP1:UP2 of greater than or smaller than 1 can also be specified. Preferably, the drive 70 for the rotation about the first planetary axis of rotation P1 is also a synchronous drive, preferably, as in the present example, a toothed belt drive, in order to ensure a predefined rotational speed ratio. The toothed belt drive 70 for driving the rotation of the grinding vessel receiving device 26 about the first planetary axis of rotation P1 is configured as a restricted toothed belt drive.

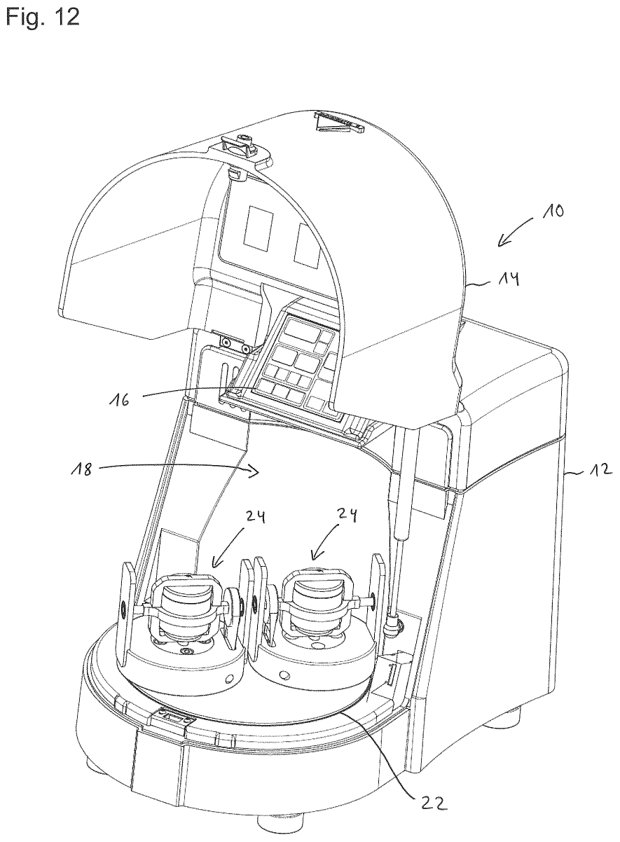

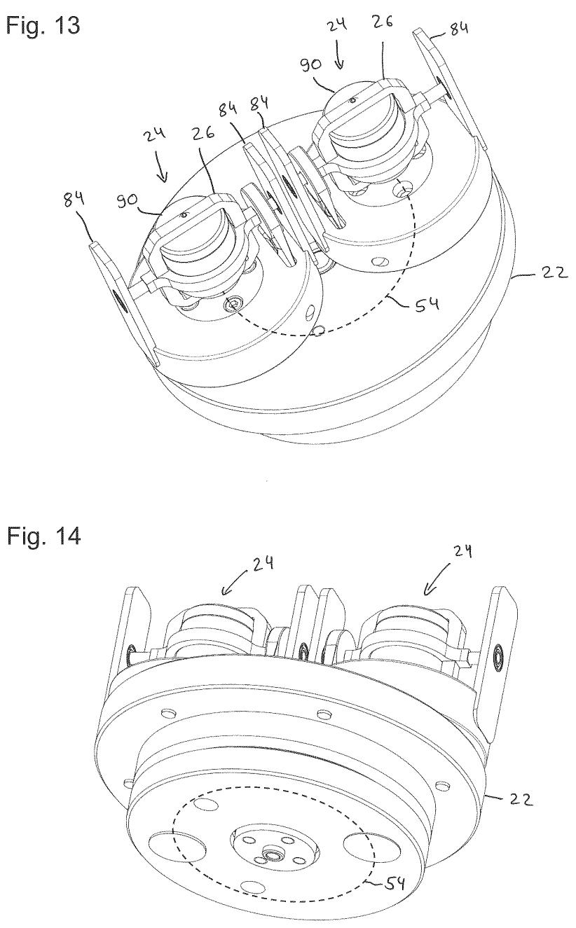

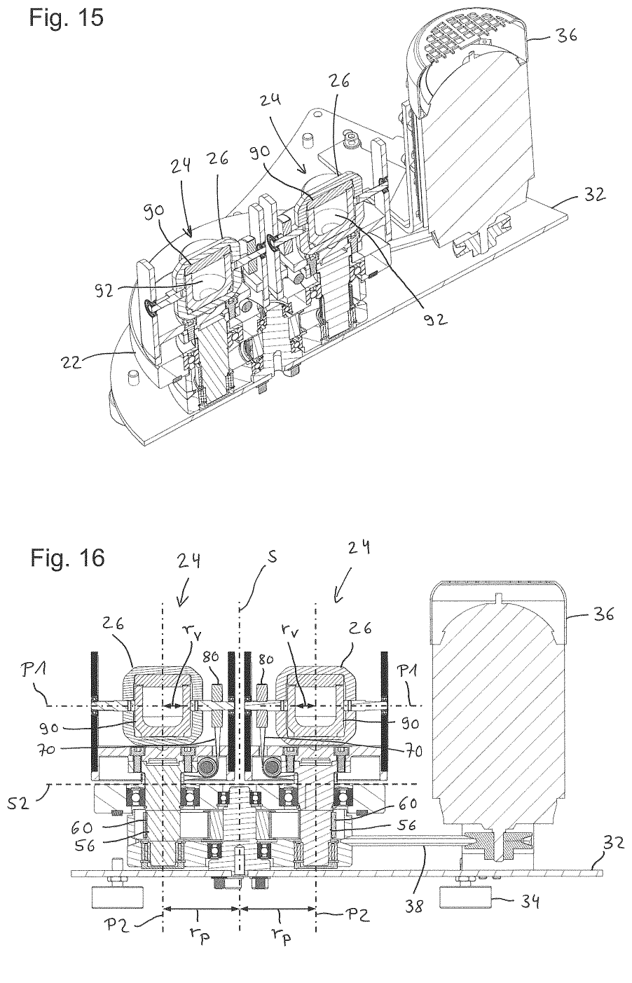

The internal radius of the grinding vessel 90 defines the planetary internal radius r_{V}. If the planetary mill 10 is intended to carry relatively large grinding vessels 90, e.g. larger than or equal to 250 ml, or even 500 ml, and nonetheless should be configured to be relatively small, a relatively small radii ratio is set between the sun radius r_{P} and the planetary internal radius r_{V}. Then, as in the example shown here, the sun axis S is located relatively close to the inside wall of the grinding vessel 90. This is possible particularly successfully in mono-planetary mills. In this case, the radii ratios r_{P}:r_{V} can be in the region of 1. In the case of a mono-planetary mill, even radii ratios r_{P}:r_{V} of less than 1, e.g. 0.8, are possible. Larger radii ratios r_{P}:r_{V} are used in particular if smaller grinding vessels 90 are used, and/or if the planetary mill 10 comprises a plurality of planetary grinding stations 24 (cf. FIGS. 12 to 16). In this case, e.g. sun radii r_{P} in the region of 70 mm and planetary internal radii r_{V} e.g. in the region of 13 mm, and thus a radii ratio r_{P}:r_{V} of approximately 5.5, is/are possible. Preferably, the radii ratio r_{P}:r_{V} can be smaller than or equal to 10, or smaller than or equal to 8, and/or larger than or equal to 0.5, or larger than or equal to 0.7. In each case, the sun axis S does not intersect the interior 92 of the grinding vessel 90 centrally, but rather merely in a peripheral edge region.

In the present example, the relative rotational speed ratio between the rotational speeds of the planetary rotation UP2 about the second planetary axis of rotation P2 to the sun rotation US is UP2:US=−2:1. In order to produce the best possible grinding effect, sufficiently high planetary rotational speeds UP2 and UP1 should be present both about the second planetary axis of rotation P2 and about the first planetary axis of rotation P1. In the case of a conventional planetary ball mill, however, the planetary rotation is subject to certain limits, since the particles may no longer detach from the grinding cup inside wall 90a if the acceleration from the planetary rotation becomes too large compared with the acceleration from the sun rotation. Optionally, this limit can be shifted in the case of a 3D rotation. In the case of a 3D planetary mill 10 as shown in FIGS. 2 to 7, a non-uniform movement can be achieved, wherein the twice-rotating planet or the grinding vessel 90, with its inside wall “under” the material to be ground, which is accelerated “outwards” by the sun rotation, reverses its direction of rotation in the reference system of the carrier device 22 or laboratory system. As a result, optionally a further, in any case different, friction between the material to be ground and optionally the grinding media and the grinding vessel inside wall 90a can be produced, which can have a helpful influence effect on the grinding effect. Therefore, the magnitude of the relative rotational speed ratio |UP2:US| can possibly be up to 25:1, wherein 0.5:1 or 1:1 can be set as the lower limit. In this case, the rotation about the planetary axis of rotation P2 can be configured so as to be synchronous with or opposing to the revolution around the sun axis S, wherein opposing is preferred.

With respect to the rotational speed ratio about the additional skewed first planetary axis of rotation P1, the magnitude of the rotational speed ratio |UP1:UP2| can be up to 5:1, possibly even up to 10:1. However, a reduction as far as 0.1:1 or 0.2:1 is also conceivable. In other words, |UP1:UP2| is smaller than or equal to 10:1, preferably smaller than or equal to 5:1, and/or larger than or equal to 0.1:1, preferably larger than or equal to 0.2:1.

Accordingly, the rotation vector of the grinding vessel 90 about the first planetary axis of rotation P1 in the reference system of the carrier device 22 or in the laboratory system regularly reverses due to the planetary rotation about the second planetary axis of rotation P2.

In the example show, the grinding vessel 90 is spherical, but inter alia grinding vessels having a cylindrical interior or elliptical interior, and in particular grinding vessels 90 having a cylindrical outside shape, can also be used.

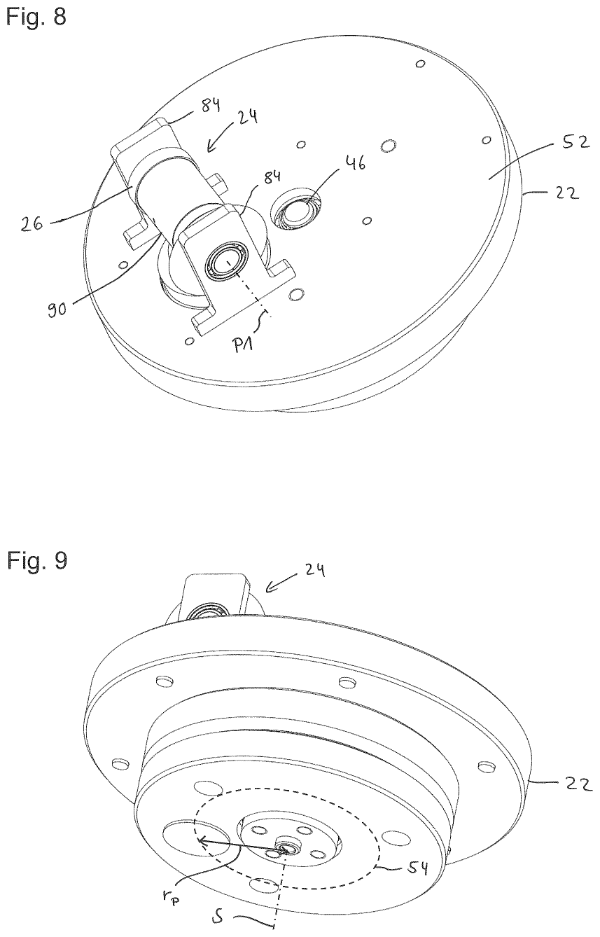

A further embodiment is shown with reference to FIGS. 8 to 11, in which embodiment the “conventional” vertical planetary axis of rotation P2 is omitted and the grinding vessel receiving device 26, comprising a grinding vessel 90 which is cylindrical in this example, performs a planetary rotation merely about one single planetary axis of rotation, specifically the first planetary axis of rotation P1, in addition to the orbital movement along the planetary orbit 54 about the sun axis S. In this example, the planetary axis of rotation P1 is always in the same orientation with respect to the carrier device 22, preferably in parallel with the rotation plane 52 and, in the present example, perpendicular to the sun radius r_{P} or tangential to the planetary orbit 54. In other words, the planetary rotation takes place about a horizontal planetary axis of rotation P1, but transversely to the sun rotation about the sun axis S. Thus, here, too, the planetary axis of rotation P1 and sun axis S are skewed relative to one another, specifically, in this example, in a fixed manner or permanently.

Unless otherwise described or evident herein, the design of the embodiment shown in FIGS. 8 to 11 is in principle identical to the design of the 3D planetary mill according to the embodiment from FIGS. 2 to 7, and therefore, to avoid repetitions, reference can be made here to what has been stated above.

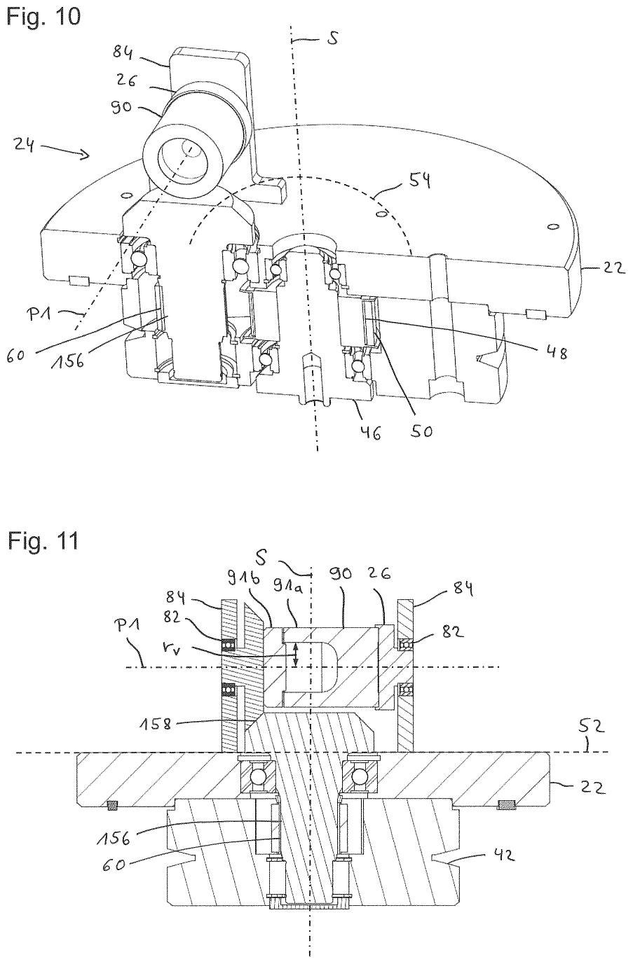

With reference to FIGS. 10 to 11, in this embodiment a planetary shaft 156 is mounted in the carrier device so as to be eccentrically rotatable, and is driven by means of a synchronous drive 50. In this example, the planetary shaft 156 drives the rotation of the grinding vessel receiving device 26 and of the grinding vessel 90 clamped therein, about the horizontal planetary axis of rotation P1, via a gear transmission 158. For this purpose, the grinding vessel receiving device 26 is mounted horizontally in the retaining device 84 of the planetary grinding station 24, by means of ball bearings 82. On account of the dynamically less complex movement regime of the material to be ground and optionally of the grinding media, in this embodiment a gear transmission that is less flexible compared with a toothed belt drive is considered suitable for driving the planetary rotation.

The grinding vessel 90 includes a grinding cup 91a and a grinding cup lid 91b which is detachable therefrom, wherein the grinding vessel is reliably locked inside the grinding vessel receiving device 26 by bracing of the grinding cup 91a and the grinding cup lid 91b. In the present example, the grinding cup interior 92 is largely cylindrical, wherein for example a rounded grinding cup base 94, as in the present case, should not be excluded. In the present example, the cylinder axis of the cylindrical grinding vessel 90 is coaxial to the planetary axis of rotation P1. However, it is also conceivable for the grinding vessel 90 to rotate upright, i.e. having a cylinder axis which extends transversely or perpendicularly to the first planetary axis of rotation P1.

With reference to FIGS. 12 to 16, a 3D planetary mill of the duo construction type, i.e. having two planetary grinding stations 24 which are opposite one another with respect to the sun axis S, is described. Unless otherwise explained or clear in the following, the duo-3D planetary mill 10 corresponds to the mono-3D planetary mill shown in FIGS. 2 to 7, and therefore, to avoid repetitions, reference can be made to this description.

In the case of the duo-3D planetary mill 10, two planetary grinding stations 24 are mounted rotatably in the carrier device 22, and specifically in particular so as to be diametrically opposite one another with respect to the sun axis S, in order to prevent imbalance. Both planetary grinding stations 24 are driven in rotation about their respectively associated planetary axis of rotation P2 by means of a belt drive 50, wherein the two planetary axes of rotation P2 extend in a manner offset in parallel with respect to the sun axis S. Both grinding vessel receiving devices 26 are in each mounted in a gimballed manner on the carrier device 22 and, in addition to the rotation about the vertical planetary axis of rotation P2, are driven in a rotating manner about respectively associated planetary axes of rotation P1 which are horizontal and thus extend in a skewed manner with respect to the sun axis S, at least most of the time. Here, too, the drive takes place, by way of example, via restricted synchronous or toothed belt drives 70 in each case.

In contrast to the embodiment in FIGS. 2 to 7, said 3D planetary mill 10 comprises two cylindrical grinding vessels 90, which each define a substantially cylindrical interior 92. The respective grinding cups 91a and grinding cup lids 91b are clamped inside the respective grinding vessel receiving device, and specifically, in the present case, in the zero position shown, coaxially with respect to the planetary axis of rotation P2. However, it is also possible to brace the cylindrical grinding vessels 90 in another orientation, e.g. in the zero position, coaxially to the first planetary axis of rotation P1. Cylindrical grinding vessels 90 can also be used in a mono-3D planetary mill or in multi-3D planetary mills, e.g. comprising 3, 4 or more grinding stations 24.

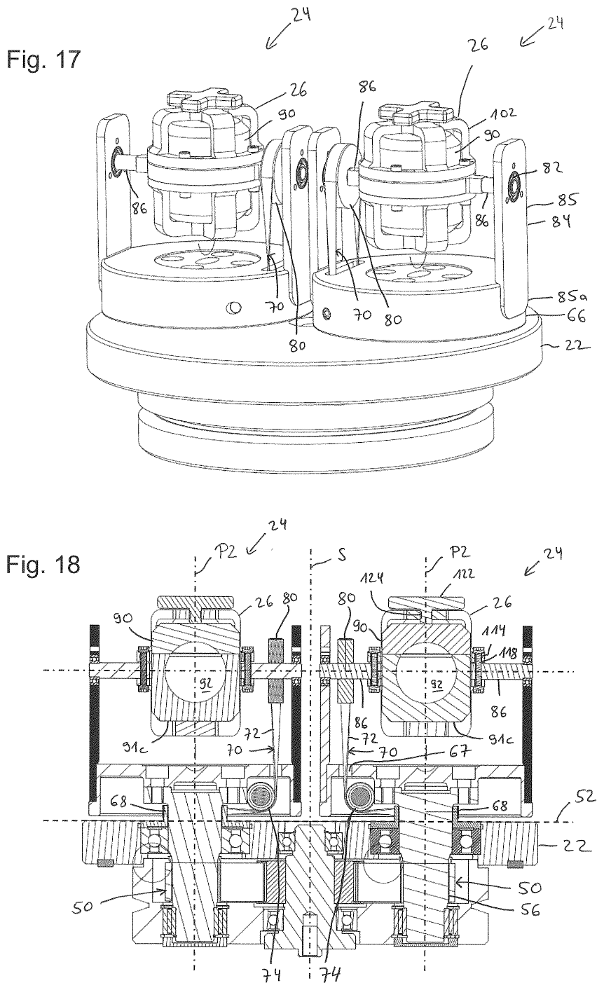

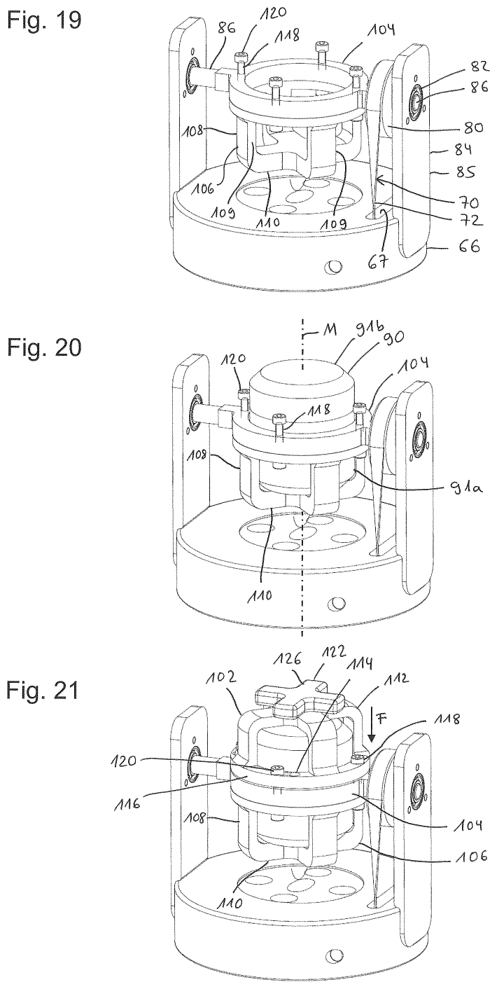

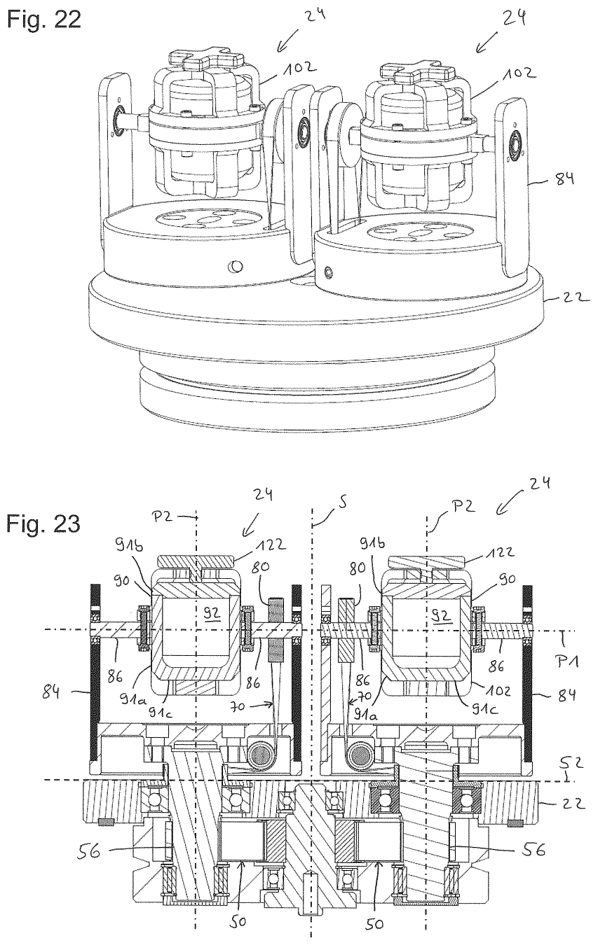

With reference to FIGS. 17 to 23, a further embodiment of a 3D planetary mill 10 is shown. The embodiment shown in FIGS. 17 to 23 shows a duo-3D planetary mill 10 comprising two grinding stations 24 which are configured so as to be mirror-symmetrically identical, so that in the following just one grinding station needs to be described, in order to avoid repetitions. It is clear that the planetary mill 10 can also be constructed as a mono or multi-planetary mill 10, e.g. having 3, 4 or more typically identical grinding stations 24.

The grinding vessel receiving device 26 includes a clamping cage 102 which is mounted so as to be freely rotatable (>360°) in the retaining device 84, via a horizontal first planetary shaft 86, by means of pivot bearings 82. The retaining device 84 comprises two cantilevers 85 which are fastened by their lower end 85a to the base element 66 of the planetary grinding station 24 and rotate about the vertical planetary axis of rotation P2 extending in parallel with the sun axis S.

As is also the case in the embodiments in FIGS. 1-7 and 12-16, the second toothed belt drive 50 drives the rotation of the planetary grinding station 24 at the second planetary rotational speed UP2 about the vertical second planetary axis of rotation P2. The first toothed belt drive 70 is arranged in the planetary grinding station 24 and rotates therewith about the second planetary axis of rotation P2. The drive toothed belt pulley 68 of the first toothed belt drive 70 is arranged coaxially with respect to the vertical second planetary shaft 56 and is rigidly connected to the carrier device 22 (sun disc), such that the rotation of the grinding station 24 or of the grinding vessel receiving device 26 with the second planetary shaft 56 about the second planetary axis of rotation P2 drives the toothed belt 72 of the first toothed belt drive 70 via the drive toothed belt pulley 68. The toothed belt 72 then in turn drives, via the output toothed belt pulley 80, the rotation of the first planetary shaft 86 connected thereto and the grinding vessel receiving device 26 connected thereto, at the first planetary rotational speed UP1, about the first planetary axis of rotation P1.

The toothed belt 72 of the first toothed belt drive 70 initially extends horizontally or in parallel with the rotation plane 52 of the carrier device 22, and is deflected by means of deflection rollers 74, in this example by 90°, into a direction perpendicular to the rotation plane 52. The output toothed belt pulley 80 is fastened to the first planetary axis of rotation P1 that is horizontal or extends in parallel with the rotation plane 52, which output toothed belt pulley is driven by the vertical portion of the toothed belt 72, in order to drive the clamping cage 102 so as to rotate about the horizontal first planetary axis of rotation P1, at the first planetary rotational speed UP1.

In the present embodiment, the drive toothed belt pulley 68 and preferably also the deflection rollers 74 are arranged under the base element 66 of the planetary grinding station 24, such that the user does not have any access to this in normal operation. The toothed belt 72 extends through an opening 67 in the base element 66, transversely to the rotation plane 52, upwards as far as the output toothed belt pulley 80 which is positioned on the first planetary shaft 86 and drives said shaft.

Accordingly, the rotation of the carrier device 22 drives the rotation of the grinding station 24 about the second planetary axis of rotation P2, via the second toothed belt drive 50. The rotation of the grinding station 24 in turn drives the rotation of the clamping cage 102 inside the retaining device 84 about the first planetary axis of rotation P1, extending perpendicularly to the second planetary axis of rotation P2, via the first toothed belt drive 70.

The clamping cage 102 comprises a cage lower part 106 having an annular portion 104 which is rigidly connected to the first planetary shaft 86. For this purpose, two shaft ends 87, which are fastened on opposing sides of the annular portion 104 and form the first planetary shaft 86, extend on both sides of the annular portion 104, horizontally and transversely outwards from the annular portion 104, as far as into the pivot bearing 82. A shell portion 108 of the cage lower part 106, having shell struts 109 extending transversely to the first planetary shaft 86 (downwards in the rest position shown) and a cage bottom 110 that is connected to the shell portion 108, is fastened to the underside of the annular portion 104. The shell portion 108 can for example be screwed onto the annular portion 104 from below. The cage lower part 106 or the annular portion 104, together with the shell portion 108 and the cage bottom 110, form a half cage that is suspended in a gimballed manner and into which the grinding vessel 90, consisting of the grinding cup 91a and the grinding cup lid 91b, detachable therefrom, can be inserted from above. The cage lower part 106 can be closed laterally and/or at the underside, also in a cup-like manner.

In order to be able to receive and brace the externally cylindrical grinding vessels 90, the clamping cage 102 defines a cylindrical interior which is adapted to the cylindrical shape of the grinding vessel 90. The grinding station 24 has enough clearance for also allowing a substantially cylindrical grinding vessel receiving device 26 of this kind to rotate freely. The externally cylindrical grinding vessel 90 and/or the clamping cage 102 define a grinding vessel cylinder axis M which, in the rest position shown, coincides with the second planetary axis of rotation P2. During operation of the planetary mill 10, the grinding vessel cylinder axis M rotates in a plane perpendicular to the first planetary axis of rotation P1, or the rotating grinding vessel cylinder axis M spans said plane. The first planetary axis of rotation P1 forms a surface normal of said plane.

The user can fill the grinding cup 91a separately from the planetary mill 10 with material to be ground and optionally with grinding media, and can close it using the grinding cup lid 91b. The user inserts the filled grinding vessel 90 manually into the cage lower part 106, as shown in FIG. 20, wherein the cage lower part 106 forms an interference fit for the grinding vessel 90. Once the grinding vessel 90, consisting of the grinding cup 91a and the grinding cup lid 91b, has been inserted into the cage lower part 106, the grinding cage 102 is closed, at its side axially (M) opposite the cage bottom 110, by a cage lid part 112, such that the grinding cup 91a, closed by the grinding cup lid 91b, is completely surrounded by the clamping cage 102. The cage lid part 112 comprises keyhole-shaped drilled holes 114 in an annular portion 116, which holes interact in a bayonet-like manner with screws 118 that are screwed into the central annular portion 104 of the clamping cage 102. In order to close the clamping cage 102, the user places the cage lid part 112 onto the annular portion 104, wherein the screw heads 120 plunge through the drilled holes 114 of the cage lid part 112, and wherein the drilled holes 114 and the screws 118 form a bayonet closure for closing the clamping cage 102. Subsequently, the user rotates the cage lid part 112 about the grinding vessel cylinder axis M, in order to close the bayonet closure, and thus the clamping cage 102. In other words, the grinding vessel receiving device 26 comprises an openable and closeable clamping cage 102, into which the grinding vessel 90 can be inserted when the clamping cage 102 is open, and which surrounds and retains the grinding vessel 90 when the clamping cage 102 is closed.

The clamping cage 102 further comprises a bracing device 122, for example in the form of a spindle 124 having a twist grip 126, which acts axially with respect to the grinding cup axis M. The user screws the spindle 124 against the grinding cup lid 91b and thus braces the grinding cup lid 91b against the grinding cup 91a, and at the same time braces the grinding vessel 90 in the clamping cage 102. The clamping force F of the bracing device 122 acts axially with respect to the grinding cup axis M and transversely to the horizontal first planetary axis of rotation P1.

During operation of the planetary mill 10, the clamping cage 102 performs a multidimensional movement, specifically revolves around the sun axis S and rotates simultaneously, preferably opposingly to the sun rotation about the second planetary axis of rotation P2, and additionally rotates about the horizontal first planetary axis of rotation P1, wherein the grinding vessel 90 is firmly and securely clamped and closed in the clamping cage 102.

After the grinding process has ended and the planetary mill 10 is stationary again, the user detaches the bracing device 122, as a result of which the bayonet closure is released and the cage lid part 112 can be removed from the cage lower part 106 again, in order to open the clamping cage 102. When the clamping cage 102 is open, the grinding vessel 90 can be removed from the open clamping cage 102 or from the cage lower part 106 again. Subsequently, outside of the planetary mill 10 the finely ground material to be ground and the grinding media can be removed from the grinding cup 91a. The grinding cup 91a and the grinding cup lid 91b can subsequently be cleaned and, after refilling, be used for the next grinding process. The user can furthermore have available a plurality of grinding vessels 90 and insert the suitable grinding vessel 90 into the grinding vessel receiving device 26 according to the grinding task, such that the planetary mill 10 is used in a flexible manner. For example, some grinding vessels 90 can be manufactured entirely of stainless steel, and other grinding vessels 90 can comprise for example ceramic or agate inserts (not shown).

The retaining device 84 or the cantilevers 85, and the entire grinding station 24, have sufficient free space for the clamping cage 102 in order that the clamping cage 102, together with the bracing device 122, can rotate freely, transversely to the grinding cup axis M, in the grinding station 24, about the first planetary axis of rotation P1, i.e. about a full 360° and beyond.

As can be seen in FIG. 18, the externally cylindrical grinding vessel 90 comprises a spherical grinding vessel interior 92, which may be helpful for some grinding tasks in the case of the 3D rotation of the grinding vessels 90. However, with reference to FIG. 23, the grinding vessel 90 can also have a cylindrical grinding vessel interior 92. A further benefit of the bracing of the grinding vessels 90 in the clamping cage 102 is that different grinding vessels 90, e.g. having different interior geometries, can be used, which may be beneficial in the 3D planetary mill 10 on account of the complex movement regime, depending on the grinding task.

In the example show, the clamping cage 102 is configured so as to be relatively open, which can have benefits with respect to the air cooling of the grinding vessels 90 during the grinding process. However, it is also conceivable to design the clamping cage 102 having smaller openings or possibly even so as to be completely closed, for example if either no significant heat development in the planetary mill 10 is to be expected, or an active cooling is provided, such that the air cooling plays a subordinate role.

The cage lower part 106, comprising the annular portion 104 and the shell portion 108, forms a cylindrical receiving fit, into which the grinding vessel 90 can be inserted. The grinding vessel 90 is guided into the annular portion 104 and/or the shell portion 108 transversely to the grinding cup axis M, in the clamping cage 102, and is braced axially with respect to the grinding cup axis M, by means of the bracing device 122, such that the dynamic forces arising during the rotation of the clamping cage 102 about the three axes, specifically the sun axis S and first and second planetary axis of rotation P1, P2, can be reliably transmitted from the clamping cage 102 to the grinding vessel 90.

Irrespective of their interior geometry, grinding cups 91a that can be removed from the planetary mill 10 and have a substantially cylindrical external shape or a substantially flat grinding cup underside 91c have the benefit that the user can simply place them on a table, with the grinding cup underside 91c, for filling and other handling.

The user can acquire the planetary mill 10 comprising a plurality of grinding vessels 90, possibly of different sizes, made of different materials, and/or having different grinding vessel interior geometries, and/or can purchase further grinding vessels 90 at a later time, or easily replace worn grinding vessels 90, which opens up a wide range of uses and is cost-effective and sustainable.

In summary, a planetary mill 10 is proposed, in which the grinding vessel(s) 90, in addition to the orbital movement round the sun axis S, rotate about at least one associated planetary axis of rotation P1 which is permanently or at least most of the time skewed with respect to the sun axis S and in the case of which the grinding vessel(s) 90 can be removed from the planetary mill 10. Furthermore, the grinding vessel(s) 90 can be suspended in a gimballed manner on the carrier device 22 rotating about the sun axis S, so as to be rotatable about in each case at least one further, i.e. in total about at least two or more planetary axes of rotation P1, P2, in order to bring further planetary rotations about further axes into the dynamic system. A suitable two-dimensional planetary rotation about two planetary axes of rotation P1 and P2 can for example be achieved in that the grinding vessel 90 is driven so as to rotate about two planetary axes of rotation P1 and P2 which are transverse, in particular perpendicular, to one another, while the grinding vessel 90 revolves on the planetary orbit 54, around the sun axis S. In this case, in some circumstances a chaotic movement regime of the grinding vessel contents can be achieved.

It is clear to a person skilled in the art that the embodiments described above are to be understood as being by way of example, and the present disclosure is not limited thereto, but rather can be varied in many ways without departing from the scope of protection of the claims. Furthermore, it is clear that the features also individually define various components of the present disclosure, even if they are described jointly together with other features, irrespective of whether they are disclosed in the description, the claims, the figures or in another way.

1. A Planetary mill for comminuting material to be ground, comprising:
a sun axis and a carrier device which is mounted so as to be rotatable about the sun axis, and a drive for rotatably driving the carrier device about the sun axis at a sun rotational speed,
a first planetary axis of rotation and a first planetary grinding station having a first grinding vessel receiving device for at least one grinding vessel that can be filled with material to be ground and grinding media, wherein the first grinding vessel receiving device together with the grinding vessel is mounted on the carrier device so as to be rotatable about the first planetary axis of rotation, eccentrically with respect to the sun axis, and is carried along by the carrier device on a planetary orbit around the sun axis when the carrier device rotates about the sun axis,
a drive for rotatably driving the first grinding vessel receiving device together with the grinding vessel about the first planetary axis of rotation at a first planetary rotational speed,
wherein during operation the first planetary grinding station revolves around the sun axis on the planetary orbit together with the first grinding vessel receiving device and the grinding vessel, and at the same time the first grinding vessel receiving device rotates about the first planetary axis of rotation together with the grinding vessel,
wherein the first planetary axis of rotation at least at times extends in a skewed manner relative to the sun axis.

2. The planetary mill according to claim 1,
wherein the first planetary axis of rotation extends in parallel with the rotation plane of the carrier device.

3. The planetary mill according to claim 1,
wherein the size of the grinding vessel and the eccentric positioning of the first planetary grinding station with respect to the sun axis are selected in such a way that the sun axis does not intersect the interior of the grinding vessel, or intersects it only in a peripheral edge region.

4. The planetary mill according to claim 1, comprising:
a sun belt drive for driving the rotation of the carrier device about the sun axis by means of a drive motor.

5. The planetary mill according to claim 1, comprising:
a first planetary synchronous drive between the carrier device and the first planetary grinding station, wherein the first planetary synchronous drive drives the rotation of the grinding vessel receiving device about the first planetary axis of rotation, synchronously to the rotation of the carrier device.

6. The planetary mill according to claim 5,
wherein the first planetary synchronous drive is configured as a first planetary toothed belt drive and comprises a drive toothed belt pulley and an output toothed belt pulley, in particular wherein the drive toothed belt pulley is connected to a sun axis end, wherein during rotation of the carrier device, the output toothed belt pulley is carried along by the carrier device on a planetary orbit around the sun axis and is thereby caused to rotate by the first planetary toothed belt drive.

7. The planetary mill according to claim 1,
wherein the relative rotational speed ratio between the rotation of the first grinding vessel receiving device, together with the grinding vessel, about the first planetary axis of rotation, and the rotation of the carrier device about the sun axis, is, according to amount, in the range between 10:1 and 0.5:1.

8. The planetary mill according to claim 1,
wherein the first grinding vessel receiving device together with the grinding vessel, in addition to the revolution on the planetary orbit around the sun axis, rotates merely about one planetary axis of rotation, specifically the first planetary axis of rotation, and wherein the first planetary axis of rotation extends so as to be constantly skewed relative to the sun axis.

9. The planetary mill according to claim 8,
wherein the first planetary axis of rotation is transverse to the radius of the planetary orbit of the first planetary grinding station about the sun axis.

10. The planetary mill according to claim 1,
wherein the first planetary grinding station is mounted, eccentrically with respect to the sun axis, so as to be rotatable about a second planetary axis of rotation together with the first grinding vessel receiving device and the grinding vessel;
wherein a drive is included for rotatably driving the first grinding vessel receiving device together with the grinding vessel about the second planetary axis of rotation at a second planetary rotational speed; and
wherein during operation the first grinding vessel receiving device together with the grinding vessel revolves around the sun axis on the planetary orbit, and at the same time the first grinding vessel receiving device together with the grinding vessel rotates about the first and about the second planetary axis of rotation.

11. The planetary mill according to claim 10,
wherein the drive for rotatably driving the first grinding vessel receiving device together with the grinding vessel about the first planetary axis of rotation at a first planetary rotational speed is configured as a first toothed belt drive, and/or the drive for rotatably driving the first grinding vessel receiving device together with the grinding vessel about the second planetary axis of rotation at a second planetary rotational speed is configured as a second toothed belt drive.

12. The planetary mill according to claim 11,
wherein the first toothed belt drive comprises at least one deflection roller and is configured as a restricted toothed belt drive.

13. The planetary mill according to claim 11,
wherein the first toothed belt drive comprises a horizontal drive toothed belt pulley which is arranged coaxially to the second planetary axis of rotation and is connected to the carrier device.

14. The planetary mill according to claim 11,
wherein the first toothed belt drive comprises a horizontal drive toothed belt pulley, a vertical output toothed belt pulley, and a restricted toothed belt.

15. The planetary mill according to claim 10,
wherein the first and second planetary axis of rotation do not extend in parallel.

16. The planetary mill according to claim 10,
wherein the first and second planetary axis of rotation extend perpendicularly to one another.

17. The planetary mill according to claim 10,
wherein the second planetary axis of rotation extends so as to be in parallel with and radially offset from the sun axis.

18. The planetary mill according to claim 10,
wherein the first and second planetary axis of rotation intersect at a point located eccentrically with respect to the sun axis, within the first planetary grinding station.

19. The planetary mill according to claim 10,
wherein the first grinding vessel receiving device is suspended in a gimballed manner on the carrier device.

20. The planetary mill according to claim 10,
wherein the first grinding vessel receiving device is mounted in a gimballed manner on the carrier device so as to be rotatable about the first and second planetary axis of rotation, wherein the gimballed mounting of the first grinding vessel receiving device is arranged eccentrically with respect to the sun axis, and wherein the first grinding vessel receiving device together with the grinding vessel is driven so as to rotate about the first and about the second planetary axis of rotation.

21. The planetary mill according to claim 10,
wherein the first planetary grinding station comprises a retaining device having at least one first pivot bearing for the grinding vessel receiving device, and wherein the first pivot bearing defines the first planetary axis of rotation,
wherein the first planetary grinding station comprises a second planetary shaft, and the carrier device comprises a second pivot bearing in the region of the first planetary grinding station, which pivot bearing defines the second planetary axis of rotation, in such a way that the first planetary grinding station is rotatably mounted in the carrier device by means of the second planetary shaft, concentrically with respect to the second planetary axis of rotation, and such that the grinding vessel receiving device is mounted in a gimballed manner on the carrier device, eccentrically with respect to the sun axis, and, during operation, is driven so as to rotate about the first and the second planetary axis of rotation.

22. The planetary mill according to claim 10, comprising:
a first and/or second planetary synchronous drive for the grinding vessel receiving device, wherein the first planetary synchronous drive drives the rotation of the grinding vessel receiving device about the first planetary axis of rotation, synchronously to the rotation of the carrier device, and/or the second planetary synchronous drive drives the rotation of the grinding vessel receiving device about the second planetary axis of rotation, synchronously to the rotation of the carrier device.

23. The planetary mill according to claim 22,
wherein the first planetary synchronous drive is configured as a first planetary toothed belt drive and comprises a drive toothed belt pulley and an output toothed belt pulley, wherein the drive toothed belt pulley is connected to the carrier device, wherein during rotation of the first planetary grinding station by means of the first planetary toothed belt drive the rotation of the grinding vessel receiving device together with the grinding vessel about the first planetary axis of rotation is driven, and/or
wherein the second planetary synchronous drive is configured as a second planetary toothed belt drive and comprises a drive toothed belt pulley and an output toothed belt pulley, in particular wherein the drive toothed belt pulley is connected to a sun axis end, wherein the output toothed belt pulley is fastened to the first planetary grinding station and, during rotation of the carrier device, is carried along by the carrier device on the planetary orbit around the sun axis and as a result the first planetary grinding station is caused to rotate by the second planetary toothed belt drive.

24. The planetary mill according to claim 10,
wherein the relative rotational speed ratio between the rotation of the first grinding vessel receiving device, together with the grinding vessel, about the second planetary axis of rotation, and the rotation of the carrier device about the sun axis, is, according to amount, in the range between 25:1 and 0.5:1, and/or
wherein the rotational speed ratio between the rotation of the first grinding vessel receiving device, together with the grinding vessel, about the first planetary axis of rotation, and about the second planetary axis of rotation, is, according to amount, in the range between 10:1 and 0.1:1.

25. The planetary mill according to claim 10, further comprising:
a second, third, fourth and/or further planetary grinding stations, which are arranged on the planetary orbit and are constructed identically to the first planetary grinding station and are in each case driven so as to rotate about their own first and/or second planetary axis of rotation.

26. The planetary mill according to claim 1,
wherein the planetary mill has at least the following structural and dynamic parameters:
sun radius, defined as the eccentric offset of the center point of the first planetary grinding station with respect to the sun axis,
planetary internal radius, defined as the internal radius of the interior for pouring in the material to be ground and the grinding media,
ratio of the sun radius to the planetary internal radius,
sun rotational speed,
first planetary rotational speed,
second planetary rotational speed,
ratio of the first planetary rotational speed to the sun rotational speed and/or
ratio of the second planetary rotational speed to the sun rotational speed,
wherein the design and dynamic parameters of the planetary mill are selected such that, during operation, the material to be ground and provided grinding media sometimes detach from the inside wall of the grinding vessel, move through the interior of the grinding vessel, and strike against the inside wall of the grinding vessel again.

27. The planetary mill according to claim 1,
wherein the eccentric offset of the first planetary grinding station with respect to the sun axis defines a sun radius between the sun axis and the center point of the planetary grinding station, and the grinding vessel defines an interior for pouring in the material to be ground and the grinding media, and the interior defines a planetary internal radius, and
wherein the ratio of the planetary internal radius to the sun radius is in the range of 1:0.5 to 1:10.

28. The planetary mill according to claim 1,
wherein the grinding vessel comprises a grinding cup and a grinding cup lid which is detachable from the grinding cup, and/or wherein the grinding vessel comprises a cylindrical, spherical or elliptical interior for pouring in the material to be ground and the grinding media, and/or has a cylindrical external shape.

29. The planetary mill according to claim 1,
wherein different grinding vessels can be exchangeably inserted into the first grinding vessel receiving device, and the grinding vessels comprise a grinding cup and a grinding cup lid that can be detached from the grinding cup in order to be able to pour the material to be ground into the grinding cup and remove it therefrom, and wherein the first grinding vessel receiving device comprises a bracing device, in order to reliably brace the grinding cup, closed by the grinding cup lid, in the first grinding vessel receiving device for the grinding process.

30. The planetary mill according to claim 1,
wherein the first grinding station comprises a retaining device and a first planetary shaft, on which the first grinding vessel receiving device is fastened and by means of which the first grinding vessel receiving device is rotatably mounted in the retaining device, wherein the grinding vessel can be inserted into the grinding vessel receiving device and be braced therein, and wherein the first grinding vessel receiving device together with the grinding vessel braced therein can rotate in the retaining device, driven at a first planetary rotational speed.

31. The planetary mill according to claim 1,
wherein the first grinding vessel receiving device comprises a clamping cage in which the grinding vessel can be braced, wherein the clamping cage comprises the following:
a cage lower part, configured for insertion of the grinding vessel, wherein the cage lower part comprises an annular portion, a shell portion that is connected to the annular portion and extends axially from the annular portion, and a cage bottom which delimits the shell portion at the bottom;
a cage lid part for closing the clamping cage, wherein the grinding vessel can be inserted into the clamping cage and removed from the clamping cage when the clamping cage is open; and
a bracing device for bracing the grinding vessel in the clamping cage when the clamping cage is closed.

32. The planetary mill according to claim 31,
wherein the cage lid part can be detachably fastened to the cage lower part.

33. The planetary mill according to claim 31,
wherein the cage lid part and the cage lower part comprise a closure, and the cage lid part is fastened to the cage lower part by the closure during operation of the planetary mill.

34. The planetary mill according to claim 31,
wherein the grinding vessel comprises a grinding cup having a grinding cup axis, and a grinding cup lid which can be detached from the grinding cup, in order to be able to pour material to be ground into the grinding cup and remove it therefrom, and wherein the grinding cup lid can be braced axially against the grinding cup by means of the bracing device, when the grinding vessel is inserted into the clamping cage.

35. The planetary mill according to claim 29,
wherein the bracing device exerts a clamping force on the grinding vessel, which force acts perpendicularly to the first planetary shaft.
